(19) United States
(12) Patent Application Publication
(10) Pub. No.: US 2013/0087050 A1
(43) Pub. Date: Apr. 11, 2013

(54) APPARATUS AND METHOD FOR NETWORKED DRINK MAKING AND DISPENSING MACHINE

(71) Applicant: Briggo, Inc., Austin, TX (US)

(72) Inventors: Charles F. Studor, Austin, TX (US); J. Kevin Nater, Austin, TX (US); Marwan Hassoun, Austin, TX (US); John S. Craparo, Georgetown, TX (US)

(73) Assignee: BRIGGO, INC., Austin, TX (US)

(21) Appl. No.: 13/649,712

(22) Filed: Oct. 11, 2012

Related U.S. Application Data
(60) Provisional application No. 61/546,040, filed on Oct. 11, 2011.

(51) Int. Cl. A47J 31/44; G06F 17/30

(52) U.S. Cl. 99/285; 99/279

(57) ABSTRACT

A system for generating beverages is provided. The system comprises a central host comprising a database, and a kiosk configured for communication with the central host. The kiosk comprises an electronic control unit (ECU), a plurality of process modules, and a memory device that is accessible by the ECU and suitable for storing information required for the operation of the kiosk. Each process module of the kiosk is configured to be controlled by the ECU to perform one or more chemical or mechanical processes contributing to the production of one or more brewed beverages. Further, information required for the operation of the kiosk is stored in the database of the central host and also stored in the memory device of the kiosk to allow the kiosk to operate independently of the central host when communication between the kiosk and central host is compromised.

### CROSS REFERENCE TO RELATED APPLICATIONS

This application claims the benefit of U.S. Provisional Application Ser. No. 61/546,040 filed on Oct. 11, 2011, which is hereby incorporated by reference in its entirety.

### TECHNICAL FIELD

This disclosure relates generally to systems and methods for generating and dispensing beverages, such as, for example, brewed beverages, and more particularly to automated systems and methods for scheduling, producing, and dispensing brewed beverages.

### BACKGROUND

Most coffee or other similar brewed beverages consumed outside of the home requires either experienced baristas, or expensive automated espresso machines. Both require significant capital to equip the retail setting, as well as logistical challenges with hiring and training personnel. The resulting retail locations require ongoing operating costs that dominate the costs associated with delivering high quality beverages. Alternatively, vending machines remove much of the cost and management difficulties, but the quality of the beverages suffers.

### SUMMARY

According to one embodiment, there is provided a system comprising a central host and a kiosk configured for communication with the central host. The kiosk comprises an electronic control unit (ECU), a plurality of process modules, and a memory device accessible by the ECU that is suitable for storing information required for the operation of the kiosk. Each of the process modules of the kiosk is configured to be controlled by the ECU to perform one or more chemical or mechanical processes contributing to the production of brewed beverages. Information required for the operation of the kiosk is stored in a database of the central host and is also stored in the memory device of the kiosk to allow the kiosk to operate independently of the central host when communication between the central host and the kiosk has been compromised.

According to another embodiment, there is provided a system comprising a central host and a kiosk configured for communication with the central host. The kiosk is further configured to receive requests for the production of one or more brewed beverages, and comprises one or more ECUs and a plurality of process modules. Each of the process modules of the kiosk is configured to be controlled by one or more of the ECUs to perform one or more chemical or mechanical processes contributing to the production of brewed beverages. One or more of the ECUs is configured to create and manage a beverage production queue for the kiosk that includes all requests for the production of one or more brewed beverages received by the kiosk, and is further configured to communicate the queue to the central host.

According to another embodiment, there is provided a system comprising a central host and a plurality of kiosks wherein each kiosk is configured for communication with the central host, and at least two of the kiosks are configured to communicate with each other. Each of the kiosks comprises an electronic control unit (ECU), a plurality of process modules, and a memory device accessible by the ECU that is suitable for storing information required for the operation of the kiosk. For each kiosk, each of process modules thereof is configured to be controlled by the ECU to perform one or more chemical or mechanical processes contributing to the production of brewed beverages. Further for each kiosk, information required for the operation of the kiosk is stored in a database of the central host and is also stored in the memory device of the kiosk to allow the kiosk to operate independently of the central host when communication between the kiosk and the central host is compromised.

### DESCRIPTION OF THE DRAWINGS

Preferred exemplary embodiments will hereinafter be described in conjunction with the appended drawings, wherein like designations denote like elements, and wherein:

FIG. 1 is a schematic and diagrammatic view of a system for producing brewed beverages;

FIG. 2 is a diagrammatic view of an exemplary beverage-producing kiosk of the system illustrated in FIG. 1;

FIG. 3 is a diagrammatic and schematic view of an exemplary interconnection of various components of the kiosk illustrated in FIG. 2;

FIG. 4 is a flow diagram illustrating an exemplary method for producing different types of brewed beverages;

FIG. 5 is a diagrammatic view of an exemplary kiosk configured to produce an espresso-based beverage;

FIG. 6 is a diagrammatic view of an exemplary process module of the kiosk illustrated in FIG. 5 in the form of an exemplary espresso unit;

FIG. 7 is a flow diagram illustrating an exemplary method for producing espresso;

FIGS. 8-12 are diagrammatic views of the exemplary espresso unit illustrated in FIG. 6 during various stages of an espresso-producing process;

FIG. 13 is a partial cross-sectional view of an exemplary brew tube of an espresso unit such as that illustrated in FIG. 6;

FIG. 14 is an isometric view of the brew tube illustrated in FIG. 13 in a partially disassembled form;

FIG. 15 is an isometric view of an exemplary sealing mechanism of the brew tube illustrated in FIGS. 13 and 14;

FIG. 16 is an isometric view of an exemplary valve assembly for use in dispensing liquid ingredients of a brewed beverage;

FIG. 17 is an isometric view of an alternate embodiment of the valve assembly illustrated in FIG. 16;

FIG. 18 is a cross-section view of a portion of the valve assembly illustrated in FIG. 17;

FIG. 19 is an isometric view of a portion of another exemplary valve assembly that is configured for use in dispensing refrigerated liquid ingredients of a brewed beverage;

FIG. 20 is an isometric view of an exemplary cooling block assembly of the valve assembly illustrated in FIG. 19;

FIG. 21 is a perspective view of an exemplary implementation of the valve assembly illustrated in FIG. 19;

FIG. 22 illustrates an exemplary graphical user interface (GUI) that may be used to order brewed beverages;

FIG. 23 illustrates an exemplary GUI that may be used to customize a brewed beverage; and

FIGS. 24 and 25 are graphical representations of an exemplary beverage production queue.

### DETAILED DESCRIPTION OF EMBODIMENTS

The methods and systems described herein may be used to produce and dispense beverages, such as, for example and without limitation, brewed beverages (e.g., hot or cold brewed beverages). For purposes of this disclosure, the phrase “brewed beverages” or “brewed beverage” is intended to mean any consumable beverage that is made through a process in which a liquid and one or more ingredients are combined though one or more of mixing, stirring, boiling, steeping, infusion, frothing, pressurization, and/or fermentation over a prescribed period of time. Examples of brewed beverages include, but are not limited to, coffee, tea, espresso, and beer. It will be appreciated that while the description below is primarily with respect to the production of brewed beverages, the present disclosure is not meant to be so limited. Rather, the methods and systems described herein may also be used to produce other types of prepared beverages, such as, for example, hot chocolate and energy drinks, to name a few. In any event, the system may be implemented as a single, fully-automated kiosk that, in an exemplary embodiment, is configured to communicate with a central host; or as a network of kiosks, each of which is configured to communicate with a central host and one or more other kiosks. The system may reduce the fixed overhead associated with serving high quality beverages, as well as the capital required to create a point-of-sale (POS) kiosk unit. The system and methods described herein may create a high quality beverage, while eliminating the need for personnel, such as, for example, expert baristas, and may maximize the intervals between required service by a technician.

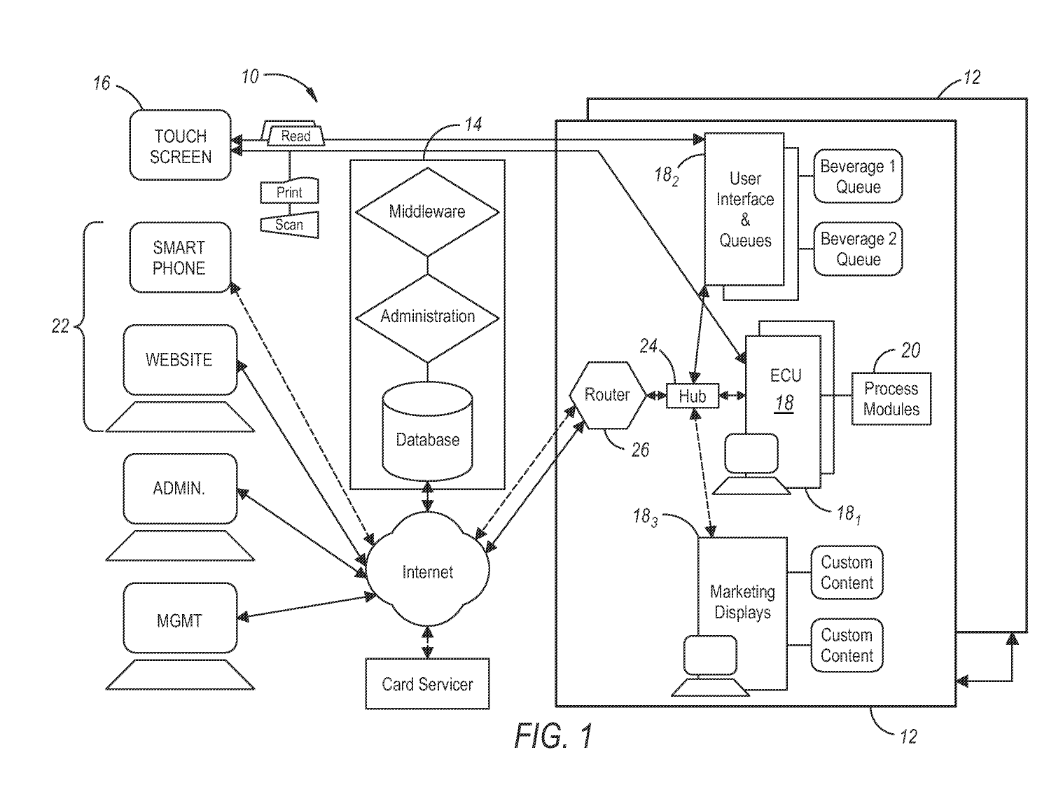

Referring now to the drawings wherein like reference numerals are used to identify identical or similar components in the various views, FIG. 1 illustrates an exemplary embodiment of a system 10 for, among other things, preparing and dispensing beverages, such as, for example, brewed beverages (e.g., coffee, espresso, tea, etc.). In an exemplary embodiment, system 10 comprises a kiosk 12 (e.g., a standalone or walkup kiosk) and a central host or datacenter 14 configured to communicate with the kiosk 12. In another exemplary embodiment, and as will be described in greater detail below, system 10 may comprise a plurality of kiosks 12, each of which is configured to prepare and dispense beverages and to communicate with the central host 14 and one or more other kiosks 12.

As described in U.S. Patent Publication No. 2012/0156337 entitled “Apparatus and Method for Brewed and Espresso Drink Generation,” hereby incorporated by reference in its entirety, in an exemplary embodiment, the kiosk 12 comprises a plurality of components that may allow for a fully automated kiosk having the functionality to, in general terms, take ground coffee or beans as an input and to produce a fully lidded brewed beverage as an output. To that end, kiosk 12 may include, among other components, one or more user interface mechanisms 16, an electronic control unit (ECU 18), and one or more process modules 20. In various embodiments, kiosk 12 may further comprise a cup handler, a lid dispenser, a completed drink presenter, a presentation area, and various actuators, sensors, and/or other components, some of which are described below.

As shown in the example illustrated in FIG. 1, kiosk 12 may include one or more user interfaces 16. A user interface may include any number of devices suitable to display or provide information to a user (e.g., customer, potential customer, administrator, service technician, etc.) and/or to receive information from a user. Accordingly, user interface(s) 16 may comprise, for example, one or more of: a liquid crystal display (LCD); a touch screen LCD (e.g., a 15-inch touch screen LCD); a cathode ray tube (CRT); a plasma display; a keypad; a keyboard; a computer mouse or roller ball; a joystick; one or more switches or buttons; a graphical user interface (GUI); a text-based interface; or any other display or monitor device. User interface(s) 16 may further include one or more of: a card reader (e.g., for credit, debit, loyalty, gift, and other like cards); a radio frequency identification (RFID) reader; a coin acceptor; a printer; a loyalty or gift card dispenser; a microphone; and/or a speaker. In an exemplary embodiment, one or more user interfaces 16 of kiosk 12 are disposed at the same location as the kiosk and may be disposed either within the outer housing thereof, or in close proximity thereto, such that it may be accessed by customers. Accordingly, and as will be described more fully below, user interface(s) 16 provide(s) an interface between kiosk 12 and a user and may be configured to permit either one-way or two-way communication therebetween.

In an exemplary embodiment, in addition to, or instead of, kiosk 12 including one or more user interfaces 16, system 10 may include one or more user interfaces 22 that are separate and distinct from kiosk 12, but that provide a direct or indirect interface between a user and one or more kiosks 12 of system 10. As with user interface(s) 16 of kiosk 12, user interface(s) 22 may be configured to permit either one-way or two-way communication between a user and one or more kiosks 12. For example, and as will be described in greater detail below, one or more components of system 10 (e.g., ECU 18 of kiosk 12, central host 14, etc.) or some other component (e.g., a software application or “app”) may be configured to generate a user interface 22 in the form of a graphical or text-based interface (e.g., having one or more user-selectable or user-inputtable fields or links) that may be displayed, as illustrated in FIG. 1, on a suitable device (e.g., smart phone, tablet, computer, PDA, etc.) and allow a user to interact or communicate directly with kiosk 12, or indirectly through, for example, central host 14. It will be appreciated that in an embodiment wherein the graphical or text-based user interface is communicated to a suitable user device, such communication may be supported or facilitated by any number of well known communication techniques and protocols, such as, for example, one or more of those described below.

As was briefly described above, in an exemplary embodiment, one or more user interfaces 16 of kiosk 12 and/or one or more user interfaces 22 of system 10 may be configured to allow for one-way communication from kiosk 12 or system 10 to a user. More particularly, user interface(s) 16, 22 may be configured to allow for the display of messages or other graphics that pertain or may be of interest to a particular user (e.g., customer-specific messages or content), or general messages/information not directed to any one person in particular. In such an embodiment, that or those user interface(s) 16, 22 may not allow for interaction on the part of the user (e.g., to respond to inquiries, place orders through the user interface, etc.). Rather, in such an embodiment, that or those user interface(s) 16, 22 are configured strictly for the display of information or other content.

Conversely, in certain embodiments, one or more user interface(s) 16, 22, may be configured to facilitate two-way communication between the kiosk 12 or system 10 and a user. More particularly, one or more of user interfaces 16, 22 may comprise an interactive interface that allows a user to interact with, for example, kiosk 12 and/or central host 14. For instance, one or more of user interfaces 16, 22 may be configured to display a message prompting a user to input certain information (e.g., the selection of a function, operation, or customization to be performed; the selection of a beverage to be produced; user identifying information; etc.), and to also provide a means by which such information may be inputted (e.g., user-selectable or user-inputtable fields or links). The input provided by the user may then be communicated to, for example, a component of kiosk 12 (e.g., ECU 18) or to central host 14, which may then take certain action in response to the received input. In an exemplary embodiment, the communication between user interface(s) 16, 22 and an intended recipient may be direct communication (i.e., electrical signals flow from the user interface directly to the intended recipient (e.g., a component of kiosk 12, central host 14, etc.)). In other exemplary embodiments, however, the communication may be indirect such that the input received at the user interface may be routed and relayed from the user interface, to one or more other components of kiosk 12 or system 10, and then to the intended recipient. For example, an input received at a user interface may be routed from the user interface to central host 14, which may then relay the input to kiosk 12. Similarly, in another example, the input received at a user interface may be communicated from the user interface to a controller or ECU associated therewith, which may then relay the input to an intended recipient such as, for example, ECU 18 of kiosk 12 or central host 14. In yet another example, the input received at a user interface may be routed through, for example, one or more intermediary components of kiosk 12, such as, for example, a hub (e.g., hub 24 in FIG. 1), a router (e.g., router 26 in FIG. 1), a modem, etc., prior to the input reaching the intended recipient. Accordingly, it will be appreciated that a user input received at a user interface may be communicated to the intended recipient(s) in any number of ways, each of which remains within the spirit and scope of the present disclosure. It will be further appreciated that whether the communication described above is one- or two-way, such communication may be supported or facilitated by any number of well known communication techniques and protocols, such as, for example, one or more of those described below.

Accordingly, in view of the above, it will be appreciated that user interface(s) 16, 22 may be configured to serve a number of purposes and to perform a number of functions, all of which remain within the spirit and scope of the present disclosure. It will be further appreciated by those of ordinary skill in the art that user interface(s) 16 and user interface(s) 22 may be configured to perform some or all of the same functionality. Accordingly, while certain functionality may described herein as being performed only by or through user interface(s) 16 or user interface(s) 22, the present disclosure is not intended to be so limited, but rather in various embodiments, and as appropriate, some or all of the functionality may be performed by either user interface(s) 16 or user interface(s) 22.

In the embodiment illustrated in FIG. 1, kiosk 12 includes an ECU 18 that may be disposed within an outer housing or enclosure of kiosk 12, or alternatively, outside of such an enclosure but in close proximity thereto. In an exemplary embodiment, ECU 18 comprises a processing unit and one or more memory or other storage devices. In other exemplary embodiments, rather than or in addition to the ECU 18 comprising a memory device, kiosk 12 may include one or more memory devices that are separate and distinct from the ECU 18 but accessible thereby. The processing unit of ECU 18 may include any type of suitable electronic processor (e.g., a programmable microprocessor or microcontroller, an application specific integrated circuit (ASIC), etc.) that is configured to execute appropriate programming instructions for software, firmware, programs, algorithms, scripts, etc., to perform various functions, such as, for example and without limitation, those described herein. The memory device, whether part of ECU 18 or separate and distinct therefrom, may include any type of suitable electronic memory means and may store a variety of data and information. This includes, for example: software, firmware, programs, algorithms, scripts, and other electronic instructions that, for example, are required to perform or cause to be performed one or more of the functions described elsewhere herein (e.g., that are used by ECU 18 to perform various functions described herein); customer-specific data and information; various data structures; operating parameters and characteristics of the kiosk and the components thereof; information (e.g., parameters, characteristics, etc.) relating to ingredients used in or by the kiosk; beverage recipes; beverage production queues; etc. Alternatively, rather than all of the aforementioned information/data being stored in a single memory device, in an exemplary embodiment, multiple suitable memory devices may be provided.

As will be described below, ECU 18 may be electronically connected to other components of kiosk 12 via I/O devices and suitable connections, such as, for example, a communications bus or a wireless link, so that they may interact as required. It will be appreciated, however, that the present disclosure is not meant to be limited to any one type of electronic connection, but rather any connection that permits communication between ECU 18 and other components of kiosk 12 may be utilized.

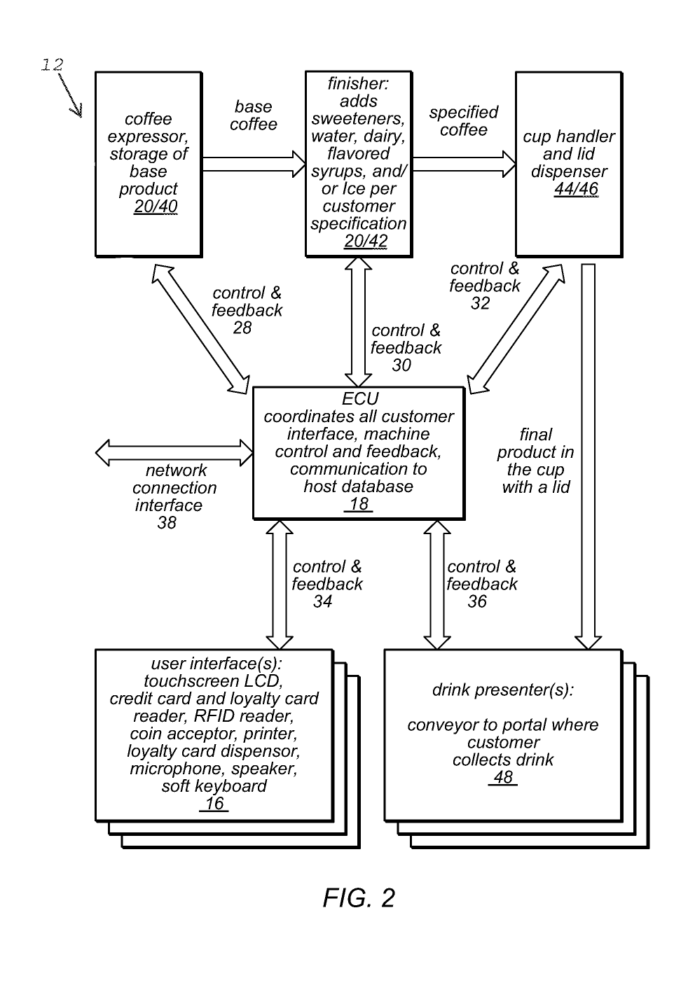

ECU 18 may be configured to perform, or cause to be performed, some or all of the functionality of kiosk 12, including, for example, some or all of those functions and features described herein. For example, and with reference to the illustrated embodiment depicted in FIG. 2, ECU 18 may coordinate all user interfaces 16, machine controls, sensors, and feedback (e.g., control and feedback illustrated at 28, 30, 32, 34, and 36 in FIG. 2), as well as communication to central host 14 and/or one or more other components or devices of system 10 (e.g., other kiosks 12 in system 10), if applicable. For example, all valves, heaters, pumps, servo motors, flow control mechanisms, and/or other mechanical components of process modules 20 described below may be controlled by ECU 18. Accordingly, in an exemplary embodiment, ECU 18 may be configured to receive a request for the production of a beverage from a user interface 16 of kiosk 12 (or from either a user interface 22 of system 10 or central host 14), and to then effect the production of the specified beverage by controlling (directly or indirectly) the operation of process modules 20 and other components required to produce the specified beverage. In an exemplary embodiment, ECU 18 may be further configured to exert at least a measure of control over one or more user interfaces 16 (and/or user interfaces 22, in certain embodiments) to cause, for example, messages to be displayed thereon notifying a customer, among possibly other things, that the production of the beverage they requested has been completed and that it is ready to be picked-up.

In addition, and as will be described below, ECU 18 may also be configured to interact with central host 14 for any number of purposes. More particularly, in an exemplary embodiment, ECU 18 provides a gateway through which central host 14 may monitor or observe the status of any or all components of kiosk 12, and/or to exert control over one or more components of kiosk 12. For example, in addition to controlling one or more servos, actuators, valves, process modules, various sensors, and/or other components of kiosk 12, ECU 18 may also be configured to receive and analyze data collected by components of kiosk 12 (e.g., sensors) to determine, for example, the state of kiosk 12 or one or more of its constituent components, information relating operational and/or environmental parameters, raw material volumes on hand, age and types of raw materials, current activity, etc. Additionally, and as will be described below, ECU 18 may be further configured to create and manage a beverage production queue for kiosk 12 and to share that queue with central host 14. In either instance, this data/information may be periodically (or on demand) uploaded by the ECU 18 to a local memory device of kiosk 12 that is part of or accessible by ECU 18, and/or to central host 14. The central host 14 may then present the data/information from the kiosk (as well as data/information from other kiosks, in certain embodiments) to, for example, users of system 10 (e.g., customers, administrators, etc.), and/or store it a database thereof. Additionally, in an exemplary embodiment, ECU 18 may be configured to determine that certain operational or environmental conditions exist, and to then provide one or more alerts to central host 10 and/or another kiosk 12 indicating the existence of such condition(s). ECU 18 may also be further configured to receive instructions from central host 14 to perform or cause to be performed certain functionality, and to then carry out those instructions.

In various embodiments, ECU 18 may be further configured to perform functionality in addition to that described above. For example, ECU 18 may be configured to determine, using techniques well known in the art, whether communication between kiosk 12 and central host 14 has been comprised (e.g., the communication link or network over which kiosk 12 and central host 14 communicate has “gone down” or is unacceptably slow, the central host 14 is not operating properly, etc.); validating, for example, credit cards and gift cards through interaction with a database or other data structure associated with central host 14; and the like.

To facilitate the interaction and communication between ECU 18 and other components of system 10 such as central host 14, ECU 18 may comprise one or more network or communication interfaces 38 that may include or be electronically connected to, and configured for communication with, other infrastructure of kiosk 12 (e.g., known components/devices such as, for example, routers, modems, antennas, electrical ports, transceivers, etc.) configured to facilitate and support one or more types of communication networks or techniques/protocols, such as, for example, those described elsewhere below. In any event, network interface(s) 38 allows for the exchange of data/information between ECU 18 and one or more other components of system 10.

It will be appreciated by those having ordinary skill in the art that while ECU 18 is illustrated in FIG. 2 as a single component, in some embodiments, the functionality of ECU 18 described herein may be performed or caused to be performed by more than one ECU or other like component. For example, in an exemplary embodiment, kiosk 12 may comprise a plurality of ECUs, each one of which is configured to perform or cause to be performed different functionality. For example, and as illustrated in FIG. 1, a first ECU (i.e., ECU 18₁) may be configured to control process modules 20 (i.e., to form a beverage production subsystem, for example), while a second ECU (i.e., ECU 18₂) may be configured to control user interfaces 16 (i.e., to form a user interface subsystem, for example), and a third ECU (i.e., ECU 18₃) may be configured to control various marketing and/or other administrative functions (i.e., to form a marketing/administrative subsystem, for example). In such an embodiment, the various ECUs may be electronically connected to each other to allow for communication therebetween, and each may be configured to also communicate with other components of system 10, such as, for example central host 14, through, for example, dedicated network interfaces or other components thereof, or common network interface(s) of kiosk 12. In another exemplary embodiment, kiosk 12 may include a number of ECUs configured to control different functionality of kiosk 12, but also includes a “master” ECU that is configured to manage and control the operation of the individual dedicated ECUs so as to have a coordinated, multi-tiered control scheme for kiosk 12. In such an embodiment, the master ECU may be the sole ECU that is configured to interface with other components of system 10, or alternatively, the individual dedicated ECUs may also be configured to interface with one or more other components of system 10 directly.

While it will be apparent in view of the foregoing that any number of suitable control schemes or arrangements employing one or multiple ECUs or other suitable control/processing devices may be used to carry out the functionality of kiosk 12 and the various components thereof, in particular, for purposes of illustration and clarity, the description below will be primarily with respect to an exemplary embodiment wherein kiosk 12 includes a single ECU (i.e., ECU 18) for controlling most, if not all, of the functionality of kiosk 12 and the components thereof. It will be appreciated by those having ordinary skill in the art, however, that the present disclosure is not meant to be limited to such an embodiment, but rather, in view of the above, any number of suitable control schemes and arrangements may be used and such other schemes and arrangements remain within the spirit and scope of the present disclosure.

In addition to the components described thus far above, kiosk 12 further comprises one or more process modules 20. Each process module 20 is configured to perform one or more chemical or mechanical processes required for producing brewed beverages. In an exemplary embodiment, each process module 20 is configured to perform one or more different mechanical and/or chemical processes than that or those performed by the other process modules. Alternatively, two or more process modules 20 may be configured to perform the same mechanical and or chemical process(es) so as to add a measure of redundancy and flexibility to kiosk 12 in case one such process module fails or is otherwise inoperable, or there is a high demand for the process(es) performed by those process modules 20.

Process modules 20 may take any number of forms. For example, and as illustrated in FIG. 2, one type of process module is an expressor unit 40 that is configured, for example, to brew coffee. Another type of process module is a finisher unit 42 that is configured, for example, to dispense one or more additives required for various beverages (e.g., flavored syrup, dairy (e.g., cold or steamed milk), ice, sweeteners, water, etc.). Accordingly, in an exemplary embodiment, kiosk 12 includes an array of process modules 20 that are configured to perform a variety of beverage production-related processes.

In any event, each process module 20 may comprise one or more components or devices for performing the chemical and/or mechanical processes that the process module 20 is configured to perform. For instance, an expressor unit 40 may comprise a number of components or devices, such as, for example, a grinder unit (configured to grind coffee beans), a tamper unit (configured to form the coffee grounds from the grinder unit into a “puck”), and a brew tube (configured to brew coffee using the puck created by the tamper unit). Accordingly, in an exemplary embodiment, one or more process modules 20 may include a combination of components or devices, each of which is configured to perform a different function. Alternatively, one or more process modules 20 may be configured to perform only one process, and therefore, may comprise a single component or device (e.g., only one of a grinder unit, tamper unit, brew tube, etc.). Accordingly, embodiments wherein a given process module 20 is configured to perform a single or multiple processes remain within the spirit and scope of the present disclosure.

As was briefly described above, in an exemplary embodiment, the operation of each process module 20 is controlled by ECU 18. Accordingly, in such an embodiment, each process module 20 is electronically connected to and configured for communication with ECU 18. It will be appreciated as described above, however, that in other embodiments, one or more process modules 20, or one or more constituent components thereof, may be alternatively controlled by dedicated ECUs that are under the control of ECU 18, or by other ECUs of kiosk 12 or system 10, such as, for example, by central host 14.

In an exemplary embodiment, such as that illustrated in FIG. 2, kiosk 12 may further comprise additional components such as, for example, a cup handler 44 and a lid dispenser 46. In one embodiment, these two components may be combined into a single apparatus, while in other embodiments they may be separate and distinct from each other. In an exemplary embodiment, cup handler 44, as the name suggests, is configured to handle or control a cup into which a specified beverage being produced by kiosk 12 is ultimately dispensed. Cup handler 44 may comprise one or more actuators (e.g., XYZ actuators) configured to move or manipulate the position of a cup into which a specified beverage is to be dispensed among locations within kiosk 12 during the production of the specified beverage. In various embodiments, these locations may include, for example: a location where empty cups are stored; a location where the beverage is dispensed into the cup (e.g., a location where a mixing chamber is disposed); locations corresponding to various process modules 20 at which different ingredients or components of the beverage may be added or dispensed into the cup; locations where partially completed and/or completed beverages are temporarily stored; a location corresponding to lid dispenser 46; and a location where a beverage presenter component of kiosk 12 is disposed. In an exemplary embodiment, the operation of the cup handler 44 is controlled by ECU 18.

In an embodiment wherein kiosk 12 includes a lid dispenser, lid dispenser 46, as the name suggests, is configured to dispense lids for placement on cups containing completed or partially completed beverages. As with cup handler 44, lid dispenser 46 may comprise one or more actuators (e.g., XYZ actuators) configured to acquire a lid and to place it on the top of a cup. Accordingly, in an exemplary embodiment, when it is determined that a lid should be placed on a particular cup, lid dispenser 46 is configured to acquire a lid from a lid storage area in kiosk 12, and to then place the lid onto the cup. As with cup handler 44, in an exemplary embodiment, the operation of lid dispenser 46 may be controlled by ECU 18.

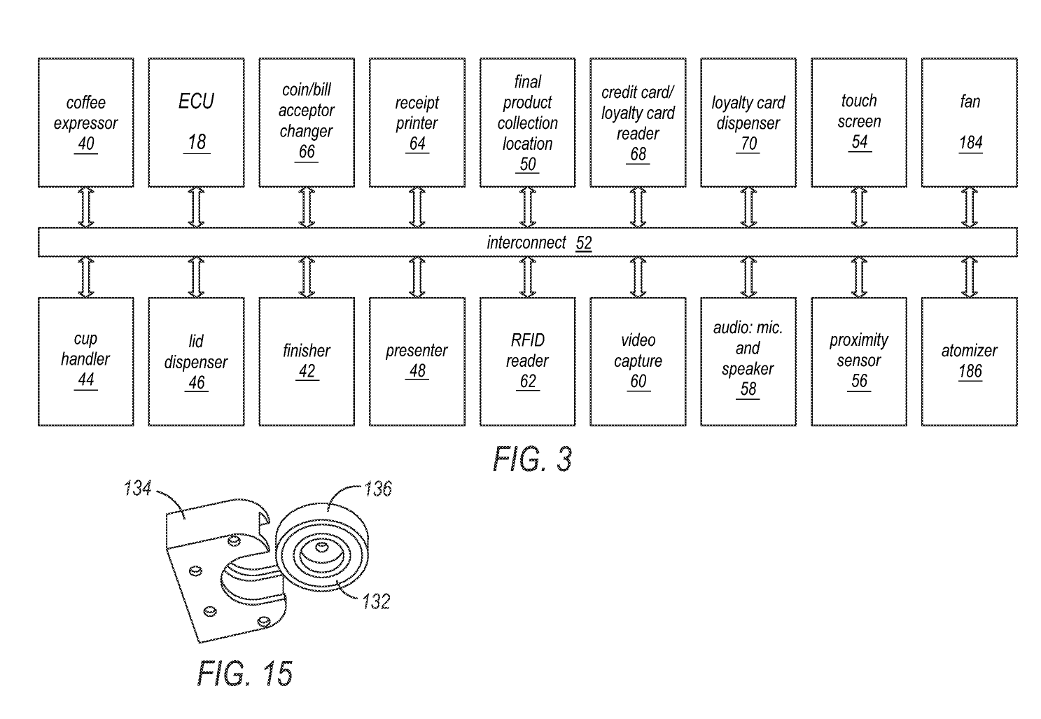

With continued reference to FIG. 2, in an exemplary embodiment, kiosk 12 further comprises one or more beverage presenters 48. Beverage presenter(s) 48 serve to transfer a completed beverage to an area at which customers may retrieve the beverages they ordered. In an exemplary embodiment, beverage presenter 48 may include, for example, a conveyor or carrousel upon which cup handler 44 places a completed beverage and that moves or delivers the beverage to, for example, a customer-accessible presentation or final product collection area 50 (illustrated in FIG. 3) where the beverage may be retrieved by the customer. This presentation area may comprise, for example, an area behind a door or window that is accessible upon the door or window opening. More particularly when a beverage is ready for retrieval by the corresponding customer, it is placed into the presentation area. When the kiosk 12 recognizes that the customer has arrived or is in vicinity of the kiosk 12 (e.g., through an input to a user interface 16 of kiosk 12), the door or window to the presentation area may be opened so that the customer may access the presentation area and retrieve his/her beverage. In various embodiments, kiosk 12 may include one or more presentation areas that may be utilized to present beverages ordered in different ways (e.g., one presentation area for beverages ordered directly at kiosk 12 for immediate delivery, and another presentation for pre-ordered beverages that are ordered in advance of a desired pick-up time). As with other components described above, in an exemplary embodiment, the operation of presenter 48 and/or presentation or final product collection area may be controlled by ECU 18.

In view of the foregoing, it will be apparent that some or all of the components of kiosk 12 are interconnected to allow for communication and exchange of information therebetween. To that end, FIG. 3 illustrates various interconnected components of an exemplary embodiment of kiosk 12. In this example, all of the illustrated components are connected to a central interconnect 52 (e.g., a communication bus), or alternatively, one or more components may be electronically connected (e.g., by one or more wires or cables, or wirelessly) to one or more other components. In the illustrated embodiment, it is through interconnect 52 that ECU 18 may receive feedback and other inputs from the other components of kiosk 12 (e.g., process modules 20, cup handler 44, lid dispenser 46, presenter 48, etc.) and may issue commands (e.g., in the form of machine instructions or signal values) to those components. In various embodiments, one or more of user interfaces 16, such as, for example, a touch screen 54, proximity sensor 56, audio interface 58 (including a microphone and/or speaker), video capture device 60, RFID reader 62, receipt printer 64, coin/bill acceptor/changer 66, credit card/loyalty card reader 68, and/or loyalty card dispenser 70, may provide a customer interface and/or maintenance interface, as controlled by ECU 18. While only certain components of kiosk 12 are illustrated in FIG. 3, in other exemplary embodiments that remain within the spirit and scope of the present disclosure, additional components, such as, for example, motion detectors or sensors, may also be included; or fewer than all of the specifically identified and illustrated components may be included.

In addition to the components described above, in various embodiments, kiosk 12 may further comprise one or more components that is/are configured to sense or otherwise acquire various parameters of ingredients that are used in kiosk 12. For example, in certain embodiments, containers or packaging in which ingredients such as, for example, coffee beans or additives are stored may have a bar code or an RFID tag associated therewith that when read may allow for ECU 18 to acquire various parameters relating to the beans or additives. For example, ECU 18 may be configured to look up an identifier received from the RFID tag or encoded by the bar code in a database or some other data structure to acquire various parameters of the corresponding ingredients. Alternatively, the parameters may be received by the ECU 18 directly from the RFID tag, or the parameters may be encoded by the bar code that may be acquired when the bar code is read (as opposed to encoding an identifier that must then be used to acquire the parameters). Accordingly, in an exemplary embodiment, kiosk 12 may further comprise an RFID reader, bar code scanner, etc., electronically connected to ECU 18 that may be used by ECU 18 to acquire various parameters of the ingredients associated with the RFID tag or bar code. In addition, or alternatively, various sensors may be used to sense one or more parameters or aspects of certain ingredients, which may allow ECU 18 to use these parameters in the control of one or more process modules. For example, kiosk 12 may include a sensor that is configured to measure the carbon dioxide content of coffee beans in the kiosk, and/or to sense the color or other parameter of the coffee beans, and to then provide this information to ECU 18.

Further, in an exemplary embodiment, kiosk 12 may also include one or more pumps (e.g., pump 71 in FIG. 3) that are each configured to drive multiple processes requiring pressurized air or gas. In such an embodiment, the pump(s) may be controlled by ECU 18 using a multi-stage process system that provides for the sourcing of air/gas at any pressure magnitude within a predetermined range. For instance, in an exemplary embodiment, the pump may be configured to source air/gas from 0-15 bar, which would satisfy operational requirements for a number of different processes performed in kiosk 12 and described below, such as, for example, sealing a brew tube (e.g., 10.5 bar), espresso expression/extraction processes (e.g., 9 bar), coffee grounds tamping processes (e.g., 3 bar), and liquid dispensing for cleaning processes (e.g., 0.6), to name a few. Accordingly, in such an embodiment, rather than requiring dedicated pumps to perform each process, for example, a single pump may be used to source multiple processes.

It will be appreciated that while certain components of kiosk 12 have been specifically identified and described above, kiosk 12 may include additional components, such as, for example, those that are described herein below. Conversely, it will be further appreciated that in certain embodiments, one or more of those components specifically identified above may not be included in kiosk 12. Accordingly, the present disclosure is not meant to be limited to any one arrangement of kiosk 12.

As described above, in an exemplary embodiment, the system 10 includes a central host 14. As illustrated in FIG. 1, and as will be appreciated by those having ordinary skill in the art, central host 14 may be implemented with a combination of hardware, software, and/or middleware, and in an exemplary embodiment, utilizes a cloud computing architecture. In an exemplary embodiment, central host 14 comprises a host server including one or more databases. The central host 14 may include one or more network or communication interfaces that may include or be electronically connected to, and configured for communication with, certain communication-supporting infrastructure (e.g., one or more known components/devices, such as, for example, routers, modems, antennas, electrical ports, transceivers, etc.) and be configured to communicate with various components of system 10, including, for example, kiosk 12 and software applications (commonly known as “apps”) executed on various types of user devices (e.g., computers, smart phones, tablets, etc.), via a public or private network (e.g., the internet) or using other suitable communication techniques or protocols, such as, for example, those described below. In an exemplary embodiment, central host 14 is located remotely from kiosk 12 (e.g., anywhere from a few feet to any number of miles from kiosk 12). Alternatively, central host 14 may be disposed within the housing of a kiosk 12.

Central host 14 may be configured to perform or cause to be performed any number of functions, and to serve any number of purposes, including, for example and without limitation, those described below. For example, central host 14 may store and, in certain instances manage, a variety of information, such as, for example, customer-specific information and/or data, and process or operational-related information for one or more kiosks 12 (e.g., beverage recipes, beverage production queues, empirically-derived profiles to be used in beverage production, component performance information, etc.). As was briefly described above, the host server 14 may be further configured to monitor and manage the operation of one or more kiosks 12, and/or to provide other functionality for efficiently operating one or more kiosks 12.

As was also described above, central host 14 may be further configured to send requests to one or more kiosks 12 to acquire various operational information from the kiosks (e.g., information relating to inventory, sales information, performance data, environmental information, customer-specific information, etc.), to receive responses containing the requested information, and to then store the requested information in one or more databases thereof, for example. The central host 14 may be further configured to respond to requests or inquiries from kiosks 12. For instance, kiosk 12 may send a request to central host 14 for updates to operational information stored locally at kiosk 12, and central host 14 may respond with the requested information. Additionally, in an exemplary embodiment, both central host 14 and kiosk 12 may be configured to send inquiries to the other (and to receive and respond to inquiries sent by the other, as appropriate) to determine whether or not it and/or the other component are functioning properly, and/or whether there is a problem with the communication link or network over which they communicate.

In addition to the above, the central host 14 may be further configured to send instructions to kiosk 12, and ECU 18 thereof, in particular, instructing it to perform certain tasks, such as, for example, to commence production of a given beverage, to shut down operation of one or more components, to display certain messages or content on a user interface 16 of kiosk 12, to name a few. Accordingly, it will be appreciated that in various embodiments, central host 14 may be configured to exert a measure of control over some or all of the features and functionality of kiosk 12.

As was briefly described above, the central host 14 may also serve as an interface to system 10, and kiosk(s) 12 thereof, in particular, for customers wishing to place beverage orders remotely from kiosks 12 (e.g., via an internet web browser, smart phone application, etc.). Accordingly, in an exemplary embodiment, central host 14 may be configured to receive requests to produce one or more beverages placed through, for example, GUIs or text-based interfaces displayed on various customer devices. For example, the central host 14 may be configured to generate or interface with GUIs or text-based interfaces having user-selectable or user-inputtable fields or links that allow for the ordering and, in certain embodiments, customization of various beverages. These orders may then be communicated from central host 14 to kiosk 12, and, in certain embodiments, ECU 18 thereof in particular.

In an embodiment wherein system 10 comprises a plurality of kiosks 12, central host 14 may be further configured to determine which kiosk 12 is best equipped produce the customer's requested beverage. This determination may be based on, for example, the ability of kiosks 12 to produce the requested beverage (e.g., in view of the availability of ingredients for the specified beverage, the operation state of the kiosk, etc.), the location of the customer relative to one or more kiosks, and/or other parameters or factors, such as, for example, current traffic conditions that may be acquired or obtained by central host 14. In such an embodiment, central host 14 may be further configured to either advise a customer which kiosk to go to, to suggest a particular kiosk, or to present the customer with a number of options from which the customer may pick.

It will be further appreciated that, as illustrated in FIG. 1, in an exemplary embodiment wherein the central host 14 is located remotely from where a system administrator or operator is located, the administrator or operator may be configured to interface and interact with the central host 14, or individual kiosks 12 through central host 14, using the same communication techniques and protocols used to support the communication between central host 14 and kiosk(s) 12, between users and central host 14 or kiosks 12, and/or, as will be described below, between individual kiosks. Accordingly, system 10 is configured to allow a system administrator or operator to easily monitor and access information relating to system 10 and the constituent components thereof.

It will be appreciated that while a number of functions performed or served by the central host 14 have been specifically identified, the description above is not intended to be an exhaustive list of the functionality of central host 14. Rather, it will be appreciated by those having ordinary skill in the art that central host 14 may be configured to perform any number of additional functions, such as, for example, those described elsewhere herein below, or to perform less than all of those functions described herein. Accordingly, it will be appreciated that central hosts configured to perform more or less functions than those described herein remain within the spirit and scope of the present disclosure.

As briefly described above, and as will be described in greater detail below, in an exemplary embodiment, system 10 may comprise two or more kiosks 12 that are configured to communicate both with central host 14, as was described above, as well as one or more other kiosks 12. Accordingly, in an exemplary embodiment, the system 10 comprises a plurality of distributed kiosks 12 networked together to generally allow for, among other things, communication and exchange information between each other, as well as between the kiosks 12 and central host 14. In such an embodiment, each kiosk 12 may be configured both structurally and operationally in the same manner as that described above and below, or one or more kiosks may vary in structure and/or operation.

In an embodiment wherein the system 10 comprises multiple kiosks 12 configured to communicate and exchange information with both central host 14 and one or more other kiosks 12, this communication and exchange of information may be facilitated across a network through one or more network or communication interfaces of the individual components (such as, for example, network interfaces 38 of kiosks 12 that may include or be electronically connected to, and configured for communication with, certain communication-supporting infrastructure, such as, for example, one or more known components/devices, such as, for example, routers, modems, antennas, electrical ports, transceivers, etc.). More particularly, the network interfaces of the individual components may support communication via one or more wired or wireless networks, such as, for example, a suitable Ethernet network; via radio and telecommunications/telephony networks, such as, for example and without limitation, cellular networks, analog voice networks, or digital fiber communications networks; via storage area networks such as Fibre Channel SANs; or via any other suitable type of network and/or protocol (e.g., local area networks (LANs); wireless local area networks (WLANs); broadband wireless access (BWA) networks; personal Area Networks (PANs) such as, for example, Bluetooth; etc.). The network or communication interfaces of the various components may use standard communications technologies and protocols, and may utilize links using technologies such as, for example, Ethernet, IEEE 802.11, integrated services digital network (ISDN), digital subscriber line (DSL), and asynchronous transfer mode (ATM), as well as other known communications technologies. Similarly, the networking protocols used on a network to which kiosks 12 and host server 14 are interconnected may include multi-protocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP), among other network protocols. Further, the data exchanged over such a network by the network interfaces of the various components may be represented using technologies, languages, and/or formats, such as the hypertext markup language (HTML), the extensible markup language (XML), and the simple object access protocol (SOAP) among other data representation technologies. Additionally, all or some of the links or data may be encrypted using any suitable encryption technologies, such as, for example, the secure sockets layer (SSL), Secure HTTP and/or virtual private networks (VPNs), the international data encryption standard (DES or IDEA), triple DES, Blowfish, RC2, RC4, R5, RC6, as well as other known data encryption standards and protocols. In other embodiments, custom and/or dedicated data communications, representation, and encryption technologies and/or protocols may be used instead of, or in addition to, the particular ones described above. Further, it will be appreciated that in an exemplary embodiment, central host 14 and kiosks 12 may each be configured to communicate with each other using more than one communication technique or protocol as a fail-safe so as to provide redundancy and flexibility in the event a given technique or protocol is rendered unusable for any reason, or different components communicate using different protocols or techniques.

In an embodiment wherein multiple kiosks 12 are networked together, the distance from one kiosk to another may range from a matter of feet (e.g., within a single building), to an unlimited number of miles (e.g., distributed globally). Accordingly, it will be appreciated that the particular communication techniques and protocols used may depend in large part on the relative distance between central host 14 and kiosks 12 and/or between the individual kiosks 12, as well as on the availability of certain infrastructure required for the various techniques/protocols (e.g., cellular reception, existence of PSTN lines, etc.). Additional functionality and features provided by a network comprising a plurality of kiosks 12 and central host 14 will be described below.

In addition to the structural components of system 10—and kiosk(s) 12 and central host 14, in particular—in an exemplary embodiment, system 10 is further configured to support a variety of functions and features in addition to those already described above. As will be described in greater detail below, this additional functionality may be performed or executed by one or a combination of the components of system 10, individual kiosks 12, and/or central host 14 described above, or one or more additional components not specifically described above either alone or in conjunction with one or more of the above-described components. Several of these various functions and features will now be described.

### Producing Beverages and Adapting Beverage Production Processes

It will be appreciated in view of the above that in various embodiments, system 10 and the methods described herein may allow for kiosk 12 to brew multiple types of beverages, and brewed beverages, in particular, using the same equipment. For example, in response to receiving a request for the production of one or more beverages, kiosk 12, and ECU 18 thereof, in particular, may be configured to control the production of the specified beverage(s) in accordance with a recipe and, in certain embodiments, one or more process profiles that are used to optimize the production process and the quality of the end product. ECU 18 may acquire the recipe and, if applicable, the process profiles, from a database that may be stored locally at kiosk 12 (e.g., in or on a memory that is part of or accessible by ECU 18), and/or remotely at, for example, central host 14. As described above, kiosk 12 may include a variety of process modules 20, each of which is configured to perform one or more chemical or mechanical processes that contribute to the production of brewed beverages. Accordingly, in an exemplary embodiment, ECU 18 is configured to control the operation of one or more process modules 20 to generate or produce the specified beverage(s), and to then effect the presentation of the beverage to the corresponding customer.

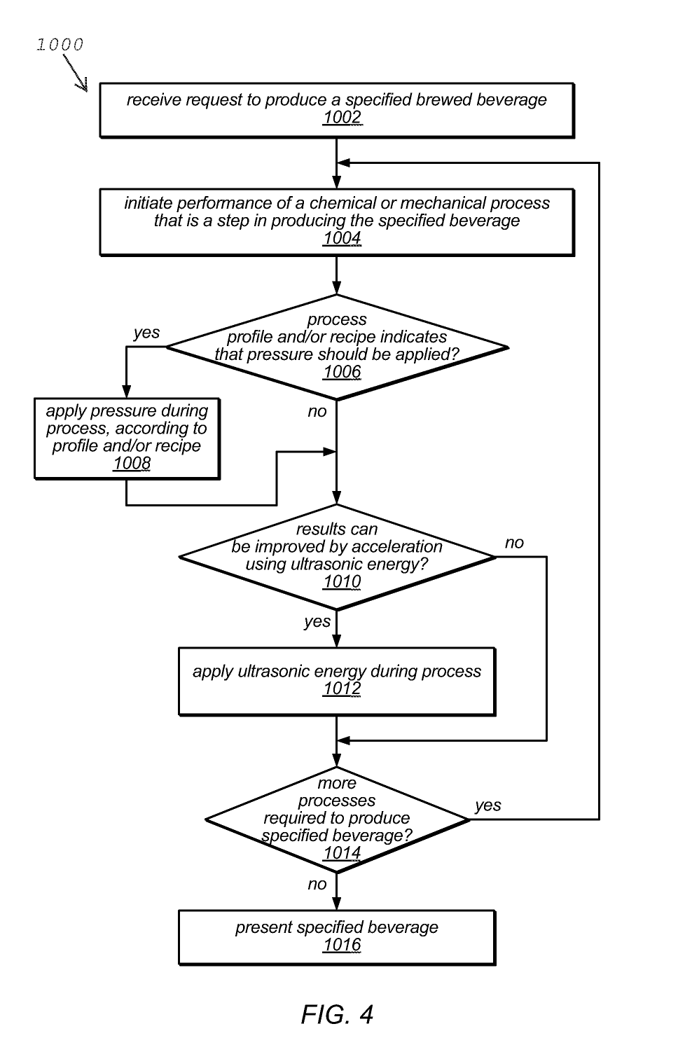

For purposes of illustration, FIG. 4 illustrates one exemplary embodiment of a method 1000 for producing different types of beverages by adaptively applying one or more chemical or mechanical processes to raw ingredients. As illustrated in this example, method 1000 may include a step 1002 of receiving a request to produce a specified brewed beverage and a step 1004 of initiating the performance of a chemical or mechanical process that is a step in producing the specified beverage. In a step 1006, a determination is made as to whether a recipe for producing the specified beverage or a profile associated with the chemical or mechanical process performed in step 1004 indicates that pressure should be applied during the performance of the process. If pressure should be applied, method 1000 may include a step 1008 of applying pressure while performing the process, according to the applicable process profile and/or beverage recipe. For example, in some embodiments, a chemical or mechanical process may be adapted for application to the production of specific beverages and/or for the production of various beverages under specific environmental or machine conditions by applying a fixed or variable amount of pressure to the process. If no applicable recipe or process profile exists for the beverage or process, or if a recipe or process profile does not indicate that pressure (e.g., pressure other than a default or standard amount of pressure applied during the process) should be applied during the process, no additional pressure would be applied during the process.

In some embodiments, the results of a chemical or mechanical process may be improved by accelerating the process (e.g., using ultrasonic transducers). As illustrated in FIG. 4, if it is determined in a step 1010 that the results of the process performed in step 1004 can be improved by accelerating the process using, for example, ultrasonic energy, ultrasonic energy (e.g., a fixed or variable amount of ultrasonic energy) may be applied during the process, as in step 1012. If the results of the chemical or mechanical process cannot be improved by the application of an accelerator such as ultrasonic energy, or if ultrasonic transducers configured to accelerate the particular chemical or mechanical process are not included, no ultrasonic energy may be applied during the process. In a step 1014, a determination is made as to whether additional processes are required to produce the specified beverage. If so, the operations illustrated in steps 1004-1014 of FIG. 4 may be repeated for each of the chemical and/or mechanical processes performed in producing the specified beverage. This is illustrated in FIG. 4 by the feedback from step 1014 to step 1004. Once all of the processes required to produce the specified beverage have been performed, method 1000 may include a step 1016 of presenting the specified beverage for retrieval by, for example, the customer that ordered the beverage.

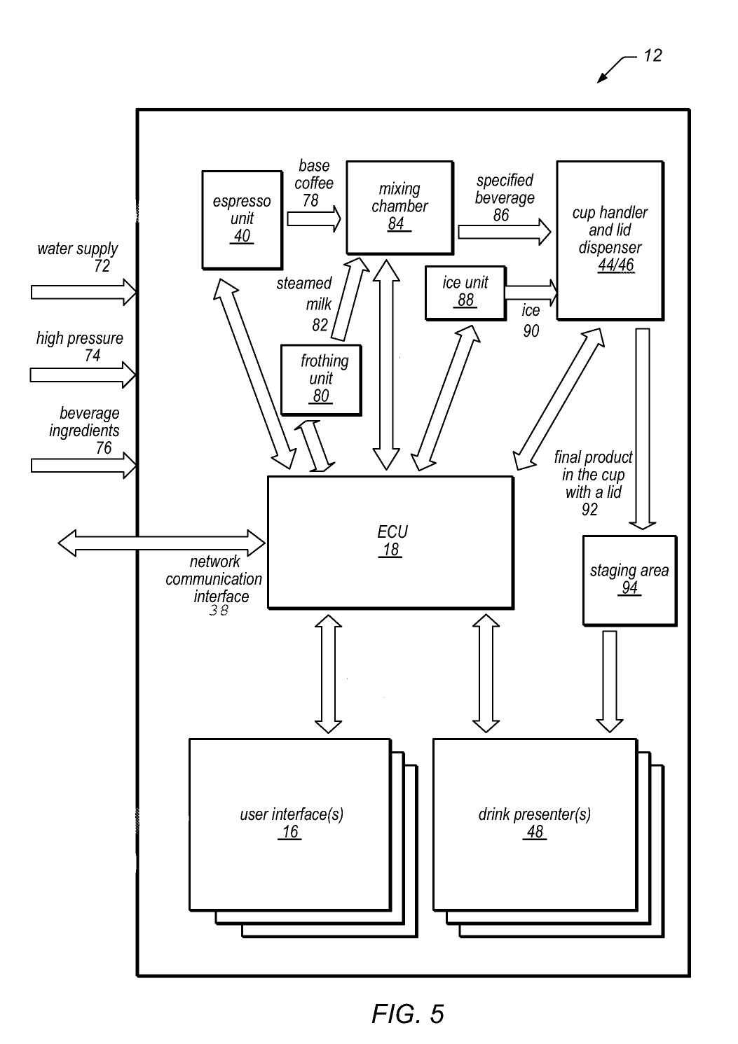

With reference to FIG. 5, a brief, general description of an exemplary kiosk 12 that is configured to produce, for example, an espresso-based beverage will be provided to better illustrate the operation of the kiosk and the various components thereof In such an embodiment, one or more external inputs to the beverage production process may be received by one or more process modules of kiosk 12. These inputs may include, for example, water 72 (e.g., through water supply), high-pressure gas 74, and beverage ingredients 76 (e.g., coffee grounds). In other embodiments, one or more of these inputs to the beverage production processes may be sourced from within the kiosk 12 (e.g., from an internal water tank, internal gas tank, and/or internal ingredient storage tanks). In the illustrated example, kiosk 12 comprises a number of process modules, such as expressor unit 40, which, in this embodiment, takes the form of an espresso unit (i.e., “espresso unit 40”). Espresso unit 40 is configured to produce a coffee base 78. Kiosk 12 further comprises another process module in the form of a frothing unit 80, which may heat and/or froth milk and provide it as steamed milk 82. In the illustrated example, the kiosk 12 may further comprise a mixing chamber 84 in which base coffee 78, steamed milk 82, and/or other beverage ingredients 76 (e.g., flavored syrups, sweeteners, etc.) may be combined to produce a specified beverage 86. In another exemplary embodiment, rather than dispensing ingredients or components of the beverage into a mixing chamber and then transferring the contents thereof to a cup that is then presented to the customer, the ingredients may be dispensed directly into the cup that is ultimately presented to the customer. In such an embodiment, the cup may remain stationary as the ingredients are dispensed therein, or it may be moved within the kiosk 12 between various locations at which ingredients are dispensed or other processes are performed. In any event, in the example illustrated in FIG. 5, if beverage 86 is an iced drink, a process module in the form of an ice unit 88 may provide ice 90 that may be dispensed into a cup along with specified beverage 86.

More particularly, and as shown in the exemplary embodiment illustrated in FIG. 5, espresso unit 40 may take water as an input, may brew coffee using any or all of the components and techniques described herein, and may store base coffee product 78 prior to its use in other stages of the beverage production flow. The water may be supplied directly from a city water supply, or it may be stored in a storage tank that is located within kiosk 12 such that gravity provides the flow of water to espresso unit 40. In this example, mixing chamber 84 may receive the base coffee product 78 as an input and may then allow for the customization the beverage, such as by adding sweeteners, diary (e.g., cold or steamed/frothed milk), water, flavored syrups, or other ingredients (i.e., additives), per the customer's or recipe's specification. In the illustrated embodiment, cup handler 44 and lid dispenser 46, which may be combined as a single component, may receive the customized coffee product 86 as an input and may package it (in some cases along with ice 90) as a final product in a cup with a lid (shown as 92 in FIG. 5). As illustrated in this example, final product 92 may be stored in a staging area 94 prior to being presented to a customer at a presenter 48 (which may comprise one of several presenters 48 of kiosk 12). In other embodiments, partially completed beverages and/or components thereof (e.g., base coffee or various combinations of ingredients) may be temporarily stored in a work-in-progress (WIP) staging area, which may comprise the same staging area in which completed beverages are stored (i.e., staging area 94), or a separate and distinct staging area.

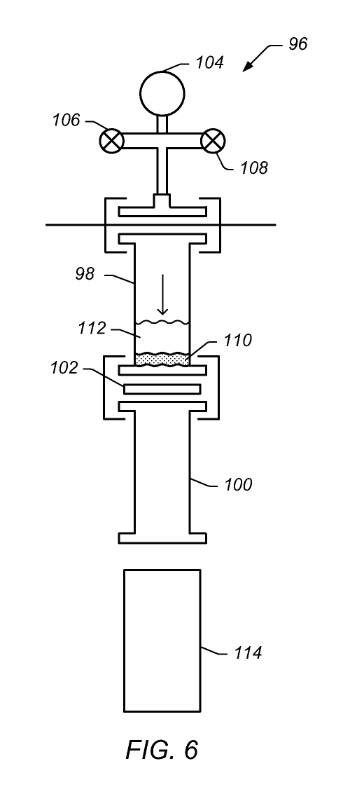

In the embodiment described above, kiosk 12 includes an espresso unit 40 that is configured to perform one or more chemical and/or mechanical processes for producing one or more brewed beverages. One embodiment of the espresso unit 40 described herein is illustrated diagrammatically in FIG. 6. It will be appreciated that while the description below is primarily with respect to an espresso unit, the description may find applicability with respect to any number of expressor units other than espresso units. In any event, in this example, espresso unit 40 comprises a brewer unit or brew tube 96. In FIG. 6, brew tube 96 is illustrated in a brewing position. As illustrated in this example, brew tube 96 may include a first chamber 98 and a second chamber 100, which, in an exemplary embodiment, are symmetrical, and are separated by a filter 102. Above the first chamber 98 is a seal mechanism 104 with a pair of ports 106, 108. In an exemplary embodiment, port 106 is used to supply hot water (e.g., 200° F. water), while port 108 is used to supply high-pressure air (e.g., 0-9 bars). The high-pressure air may be supplied by a pump disposed within kiosk 12 that is either a dedicated pump or, as was described above, a pump that is configured to source or drive a number of different processes performed during the production of various beverages. In some embodiments, espresso unit 40 may include additional ports to exhaust the pressurized air after an extraction process using high-pressure air is completed (not shown).

In this example, the first chamber 98 may be sealed using seal mechanism 104 once a desired amount of coffee grounds are introduced therein from, for example, a grinder unit disposed above chamber 98, and, in an exemplary embodiment, have been tamped by a mechanical tamper, resulting in compressed coffee grounds 110. Hot water, represented as 112 in FIG. 6, may then be introduced into first chamber 98 with grounds 110 and the brew process may commence. As illustrated in this example, a container 114 (e.g., a mixing chamber, a cup, a storage container, etc.) may be positioned below brew tube 96, and second chamber 100 thereof, in particular, to collect expressed coffee resulting from the expression of hot water 112 through compressed coffee grounds 110.

In some embodiments, the use of incremental compaction of the coffee grounds may enable the brewing of different beverages and/or variations of a brewed beverage using the same structure (e.g., brew tube). Such incremental compaction of the coffee grounds may be used to maintain consistency throughout the compacted coffee grounds or what is commonly known as the coffee or espresso “puck.” Note that as used herein, the term “puck” may refer to a compressed cylinder of ground coffee, including coffee grounds that have been compacted using any of the methods or mechanisms described herein (e.g., coffee grounds 110 in FIG. 6, hereinafter referred to as “puck 110”). Compacting incremental amounts of grounds may facilitate more efficient compaction and may result in, for example, smaller amounts of grounds being consumed per espresso shot. For example, in a typical expression process, in which an entire puck of coffee grounds is compacted at once, only the top layer of the coffee grounds is actually compacted because the applied force is dissipated in the top layer, leaving the lower levels of the puck substantially unaffected by such a compaction process.

In some embodiments, a grinder unit described elsewhere herein may dispense a portion of the coffee grounds to be used for a particular extraction operation into a chamber of a brew tube. In such embodiments, a tamper unit may be used to compact that portion of the grounds in the brew tube chamber, and then the process may be repeated until all the coffee grounds to be used for that particular extraction operation have been dispensed and compacted (e.g., in layers). In some embodiments, this incremental compaction technique may create a consistently compacted puck. The net effect of the incremental compaction may be that the compacted coffee grounds more efficiently slow the water flow during extraction, and smaller amounts of coffee grounds may be required to create, for example, each espresso shot.

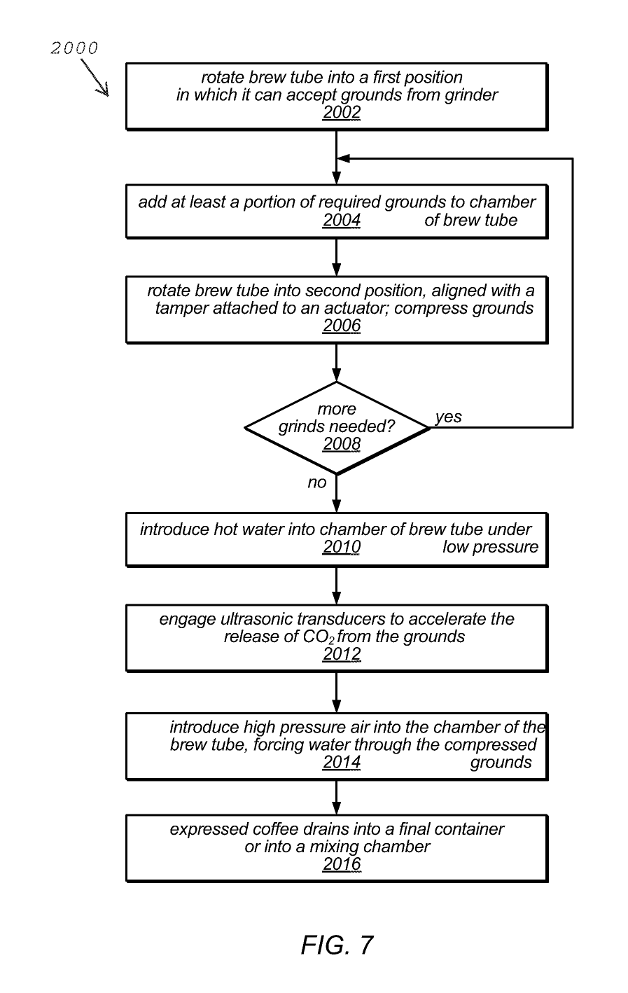

For purposes of illustration, FIG. 7 depicts an exemplary method 2000 for producing espresso in systems such as those described herein. In an exemplary embodiment, method 2000 may include a step 2002 of rotating a brew tube into a first position in which it can accept grounds (e.g., coffee grounds) from a grinder unit, and a step 2004 of adding at least a portion of the grounds required to produce a brewed beverage to a chamber of the brew tube. For example, and for the reasons described above, in some embodiments, the grounds required to produce a given beverage may be incrementally added to and compacted in the brewing chamber, rather than being added all at once.

Method 2000 may further include a step 2006 of rotating the brew tube into a second position, such that it, and the chamber thereof within which the grounds are disposed, in particular, is aligned with a tamper attached to an actuator. While the brew tube is in this position, the grounds in the chamber may be compacted by the tamper. In a step 2008, a determination is made as to whether more grounds are needed to produce a particular espresso-based beverage. If it is determined in step 2008 that more grounds are in fact needed, the method may include repeating steps 2004-2008 until the required amount of grounds have been added to the chamber of the brew tube and compacted by the tamper. Once the required amount of grounds have been added to the chamber and compacted by the tamper, the method may include a step 2010 of introducing hot water into chamber within which the grounds are disposed under low pressure.

In some embodiments, method 2000 may include a step 2012 of engaging one or more process accelerators, such as, for example, ultrasonic transducers, to accelerate the release of carbon dioxide from the grounds during a pre-infusion stage. As illustrated in this example, method 2000 may further include a step 2014 of introducing high-pressure air into the chamber, which may act to force the hot water through the compressed grounds. Introducing pressure as illustrated in step 2014 is also considered a process accelerator. For example, in some embodiments, air at nine (9) bars may be introduced into the chamber during the production of espresso, or air at a slightly lower pressure may be introduced into the chamber to perform a French press type process. Once the hot water has been forced through the compressed grounds, method 2000 may include a step 2016 of draining the expressed coffee (or coffee base) into a final container (e.g., cup) or, as described elsewhere herein, into a mixing chamber or some other storage container. It should be noted that in other embodiments, a method for producing espresso may also include an optional pre-heating operation in which the brew tube (or various portions thereof) are heated prior to one or more steps of an expression process.

Portions of an expression process, such as the exemplary espresso process illustrated in FIG. 7, may be further illustrated by the FIGS. 8-12. For example, FIG. 8 illustrates some of the operations of an espresso unit, such as, for example, espresso unit 40 described above, during a first step of an espresso expression or extraction process, according to some embodiments. In this example, brew tube 96 of espresso unit 40 is rotated to a position in which a grinder or grinder unit 116 can dispense a prescribed amount of ground coffee 118 into first chamber 98 of brew tube 96. In an exemplary embodiment, grinder unit 116 may comprise a component of espresso unit 40, or alternatively, may be a separate and distinct process module 20 from espresso unit 40 but configured for use therewith. Additionally, and for purposes that will be described below, in an exemplary embodiment, grinder unit 116 may include a worm gear 120 attached to a stepper or DC motor 122. In an exemplary embodiment, the operation of grinder unit 116 may be controlled by, for example one or more of ECU 18, another component of kiosk 12, and/or central host 14.

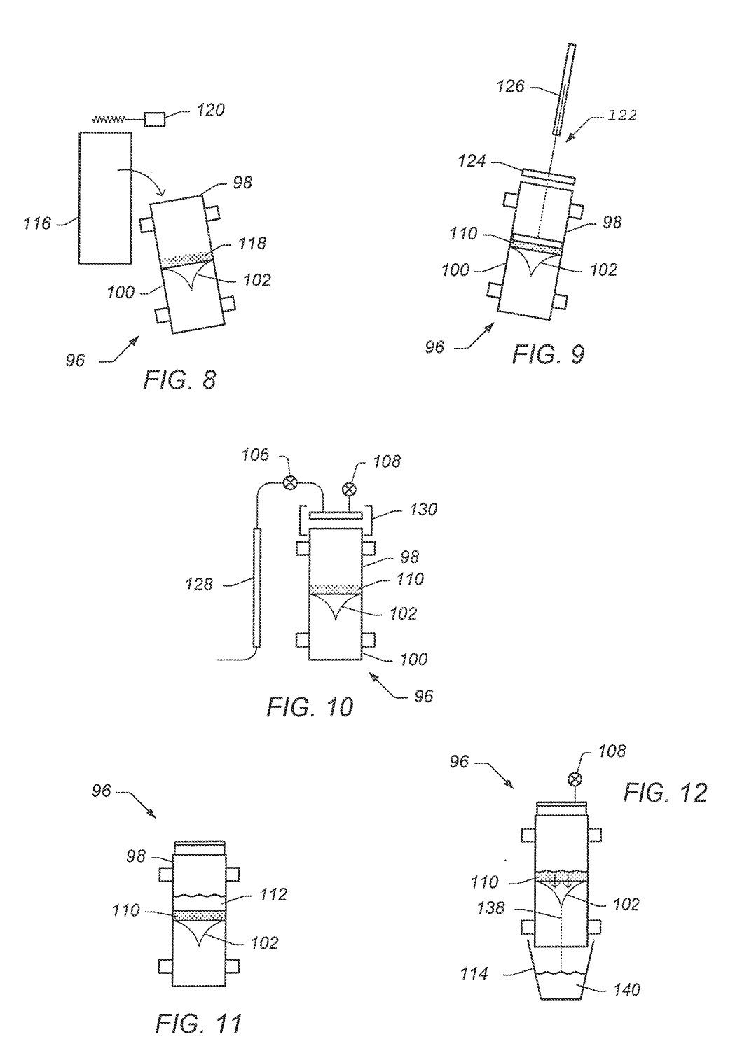

Turning now to FIG. 9, some of the operations of espresso unit 40 during a second stage of an espresso extraction/expression process are shown, according to some embodiments. In this example, brew tube 96 has been rotated to an alternate position from that in which the coffee grounds were dispensed into chamber 98 so that chamber 98 is in alignment with a tamper unit 122 comprising a tamper 124 attached to an actuator 126. The dotted line in FIG. 9 is intended to show the path along which tamper 124 travels as actuator 126 is enabled. When tamper 124 is depressed into chamber 98 of brew tube 96, the coffee grounds therein (e.g., grounds 118 in FIGS. 8 and 9) are compressed in the same manner in which they would be pressed by a human barista to form coffee or espresso puck (i.e., puck 110). Tamper 124 may then be retracted to an elevation above brew tube 96 high enough to allow further movement or rotation of brew tube 96. In some embodiments, tamper 124 may be formed out of a block of Teflon to minimize the disturbance of puck 110 when tamper 124 is removed. Not illustrated in FIG. 9 is the rotary action of tamper 124 as it comes in contact with the coffee grounds when it is depressed. In some embodiments, this rotation may continue in the same direction as tamper 124 is raised, while in other embodiments, tamper 124 may follow a combination of rotational movements in various directions when it is depressed. In some embodiments, such rotary actions of tamper 124 may form a smooth surface on the top of puck 110, which in turn may lead to a more uniform extraction of the coffee. In any event, once grounds 118 are sufficiently compressed to form puck 110, chamber 98 of brew tube 96 may then be ready for the introduction of water on top of puck 110. As with grinder 116 described above, in an exemplary embodiment, tamper unit 122 may comprise a component of espresso unit 40, or alternatively, may be a separate and distinct process module 20 from espresso unit 40 but that is configured for use therewith. Further, in an exemplary embodiment, the operation of tamper unit 122 may be controlled by, for example one or more of ECU 18, another component of kiosk 12, and/or central host 14.

FIG. 10 illustrates a next step in an espresso extraction/expression process, according to some embodiments. Specifically, FIG. 10 illustrates some of the operations of espresso unit 40 during the actual extraction/expression process. For example, an industrial water heater (e.g., an in-line water heater, shown as 128) may supply hot water to first chamber 98 of brew tube 96 for use in the extraction process. In this example, the top of brew tube 96, and chamber 98, thereof, in particular, is sealed, e.g., with a rotary actuator or some other efficient automatic sealing mechanism (shown as 130 in FIG. 10). In some embodiments, the hot water may be under low pressure (e.g., on the order of 30 psi), in contrast to the hot water in a typical espresso machine (which may be maintained in a hot water tank pressurized to 9 bars). A valve 106 may be opened to introduce the hot water into chamber 98 of brew tube 96.

Once the prescribed amount of water has been introduced to chamber 98, high-pressure air (which may already be available in the system for various actuators and/or fluid delivery systems) may be introduced through, for example, valve 108. This may bring the air above the water (which is above the coffee or espresso puck 110) up to approximately 9 bars of pressure. In some embodiments, this pressure may force the hot water through coffee or espresso puck 110. Note that, in contrast to the operation of a typical espresso machine, in some embodiments of espresso unit 40 described herein, the water is not introduced under high pressure, but rather the water is introduced under low pressure and the air is introduced under high pressure. The use of high-pressure air rather than high-pressure water may reduce cost and complexity, while increasing reliability, since air may be much easier to handle under high pressure than hot water.

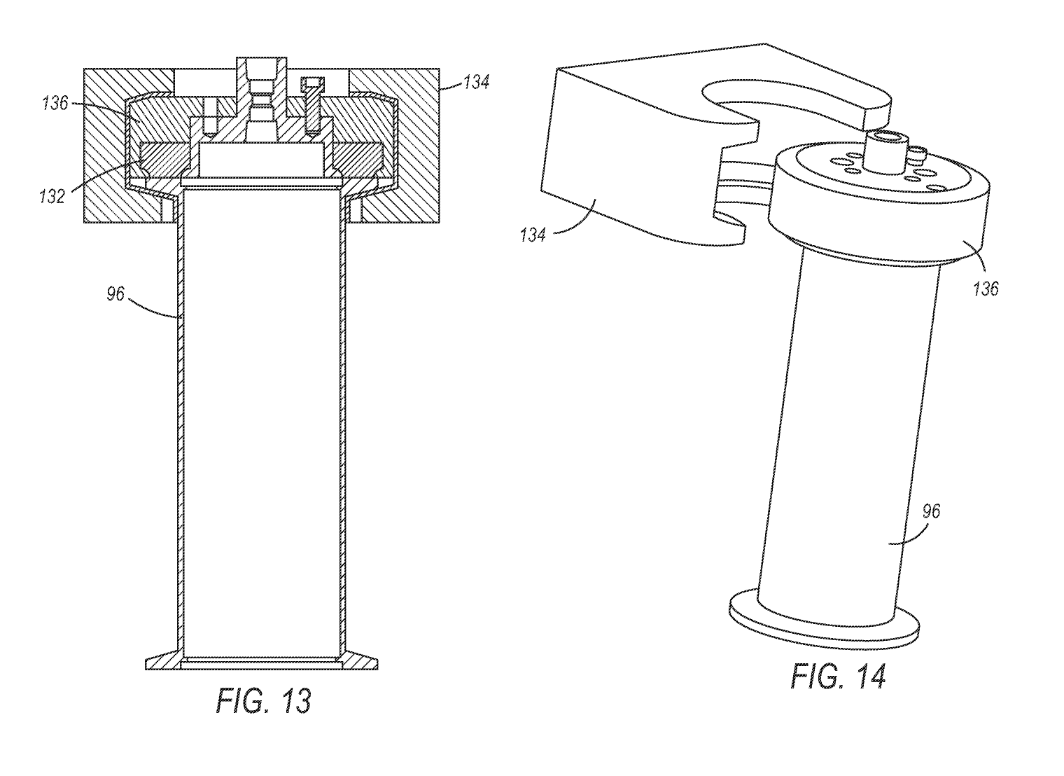

It should be noted that while FIG. 10 illustrates one possible mechanism for sealing brew tube 96 (e.g., using a rotary actuator), the present disclosure is not meant to be limited to such a mechanism. Rather, in other exemplary embodiments, actuators with leverage to seal brew tube 76 may be employed. For example, actuators may apply horizontally opposing forces to drive a wedge shape that creates a vertical movement with significantly more force than the actuators alone may achieve. Alternatively, and with reference to FIGS. 13-15, in another exemplary embodiment, brew tube 76 may be sealed by an inflatable gasket 132 disposed within a lid of brew tube 96. More particularly, the combination of inflatable gasket 132 formed of, for example, silicon, a clamp 134, and a brew tube lid 136 may be used to seal brew tube 76 when the gasket is inflated with either a liquid or gas (e.g., a pressure of approximately 10.5 bars supplied by, for example, a shared pressure source as described above). Once gasket 132 is inflated, the pressure in chamber 98 of brew tube 96 may be increased as needed (e.g., to 9 bars as described above). Accordingly, it will be appreciated that brew tube 96 may be sealed in any number of ways, including, but not limited to, those specifically described above.

With reference to FIG. 11, once brew tube 96 is sealed, water may be dispensed into chamber 98 under low pressure (shown as water 112 in chamber 98), such that there is no pressure in the chamber for the initial moments. This may allow carbon dioxide to escape the coffee grounds when water first comes in contact with the grounds. This may be referred to as the pre-infusion stage. In one example, approximately 2.5 oz of hot water may be dispensed into chamber 98 to extract 2.0 oz of espresso when the water is forced through espresso puck 110 and then through filter 102, which in an exemplary embodiment, comprises a sintered filter. In this example, approximately 0.5 oz. of water may be retained in the coffee grounds.

FIG. 12 illustrates yet another step in an espresso extraction/expression process, according to one embodiment. In this example, chamber 98 of brew tube 96 is pressurized to a certain pressure magnitude, which, in an exemplary embodiment, may be approximately 9 bars of pressure, using pressurized gas (e.g., air or any of a variety of other available compressed gasses) that is introduced into the chamber through pressurized gas valve 108. In this example, pressurizing chamber 98 forces the water 112 through the coffee puck 110. The resulting espresso 138 then passes through filter 102 and drains into a cup 114 or some other container such as, for example, a mixing chamber or storage container, that may or may not already include another liquid (e.g., one or more additives, such as, for example, a milk product 140).

As described in U.S. Patent Publication No. 2012/0156337, the entire disclosure of which was incorporated herein by reference above, in various embodiments, one or more processes performed in the production of a beverage or a component thereof, such as, for example, the extraction/expression process described above with respect to FIGS. 7-12, may be adaptively adjusted or otherwise controlled by one or a combination of components of system 10. Such processes may be adapted or controlled to take into account or compensate for various parameters (e.g., environmental and/or operational parameters) or other conditions or characteristics relating to those processes, and/or the particular beverage or component thereof being produced. The ability to adaptively adjust or control such processes may provide some assurance that those processes are being optimally and efficiently performed, and that the quality of the end product is likewise optimized.

In certain embodiments, various process profiles or metrics may be used to determine whether an adjustment to a particular process, or an operational parameter or characteristic thereof, in particular, should be made. More particularly, for any given process performed in the production of a beverage, one or more empirically-derived process profiles or other metrics (e.g., data structures) that take into account one or more parameters (e.g., operational or environmental parameters), conditions (e.g., customer preferences, type or condition of equipment used), and/or characteristics (e.g., type and/or age of coffee beans from which grounds were produced, length of time since the beans were roasted and/or ground, etc.) relating to the beverage and/or the production process corresponding thereto, may be used to evaluate the performance of the given process. In at least certain instances, the same or other process profiles or other metrics may allow for a determination to be made as to whether some action relating thereto is required or necessary, and further, what that action comprises. For example, if it is determined that some operational parameter of a given process has deviated (or, in an exemplary embodiment, unacceptably deviated) from a particular target, remedial action may be taken with respect to that process in order to correct the deviation. In certain embodiments, the beverage or the particular component thereof being prepared when the deviation is detected may be also discarded or wasted rather than being provided to the customer or used as an ingredient in the beverage.

Depending on the particular process being evaluated or monitored, a deviation from a target may occur for a number of reasons. For example, for an expression or extraction process such as that described above, deviation from a target profile may result from, for example: a poorly formed coffee or espresso puck due to incomplete grinding; application of the wrong tamp pressure during puck formation; various environmental parameters, such as, for example, ambient temperature, humidity, and barometric pressure; various operational parameters relating to the performance of the process; quality and characteristics of raw materials that are being used; and any number of other potential failures, deterioration or maintenance needs relating to the relevant equipment being used and the particular process. In an instance wherein an extraction or expression process is evaluated and it is determined that an adjustment to the process is necessary, any number of process or operational parameters relating to the extraction/expression process may be adjusted. These include, for example and without limitation, the pressure of the air or water used to force water through the coffee or espresso puck; grind size of the grounds produced by a grinder, the length time the grounds are tamped during a tamping process, and the pressure applied to the grounds during a tamping process.

For example, in an exemplary embodiment, the grind size of grounds used to generate an espresso shot may be adjusted based on the amount of time it takes (or has taken) to generate or pull an espresso shot. More particularly, if a shot takes (or has taken) longer than a prescribed or expected amount of time, the grind size may be increased to allow the water to flow more freely through the coffee or espresso puck during the next espresso pull. This may serve to avoid over extraction, which can result in a bitter flavor in the final beverage (i.e., end product). Conversely, if the shot took less than the prescribed or expected amount of time, the grind size may be decreased prior to the next espresso pull. This may serve to avoid under extraction, which can result in a loss in body and/or flavor in the final beverage. Accordingly, in such an embodiment, one or more empirically-derived process profiles or other suitable metrics or data structures (e.g., look-up tables) that take into account one or more operational parameters, including, for example, expression or extraction time, may be used to determine whether an adaptive adjustment to the grind size of the grounds produced by the grinder is required, and if so, to make appropriate adaptive adjustments to the operation of the grinder (e.g., speed, grind time, etc.).

More particularly, and for purposes of illustration only, in an exemplary embodiment, a control loop may be utilized to measure the amount of time it takes for an espresso shot to be generated, and a container configured to accept the generated espresso shot may rest on a load cell or on another type of electronic weighing device. In such an embodiment, there may be an intended (or expected) target time for generating the espresso shot. As the shot is extracted, the cup weight may be tracked along a time/weight profile that was empirically derived for either the particular espresso shot being generated or the final espresso-based end product. In an exemplary embodiment, if the espresso shot extraction rate does not track the intended profile (and, in an exemplary embodiment, is outside of an acceptable tolerance range thereof), the grind size may be appropriately adjusted for the next time the extraction/expression process is performed. More specifically, if the shot is taking too long to extract, the grinder may be adjusted so that it produces grounds having a larger grind size. Conversely, if the shot happened to fast, the grinder may be adjusted so that it produces grounds having a smaller size. The determination of the appropriate grind size to use, and therefore, the adjustments to make to the grinder may include, for example, the utilization of one or more profiles, metrics, or data structures. In addition to adjusting the grind size for the next or some other future extraction/expression process, in an exemplary embodiment, if it is determined during the production of a shot is outside of a desired profile, the generated shot may be discarded or wasted and the extraction/expression process may be repeated using grounds having the adjusted grind size.

In other exemplary embodiments, grind size may be similarly adaptively adjusted to compensate for other parameters or conditions. For example, in an exemplary embodiment, grind size may by adjusted to compensate for degradation in the equipment used to perform one or more particular processes (or one or steps thereof), such as, for example, the grinder itself. More particularly, over time, the blade of the grinder may shift, which may alter the grinding of coffee beans fed into the grinder, and therefore, characteristics of the coffee grounds produced thereby. Further, grind size may also be adjusted to compensate or account for one or more environmental conditions/parameters that may exist (e.g., ambient temperature, humidity, barometric pressure, etc).

In such embodiments, the performance of the grinder and/or one or more environmental conditions/parameters may be monitored using suitable sensors that are configured to measure or monitor the environmental and/or operational parameters of interest, such as, for example, temperature, voltage, number of grinder cycles, and the weight and/or dampness of grounds produced by the grinder, to name a few. Based on one or more of the monitored parameters a determination can be made as to whether an adjustment to the grind size of the grounds produced by the grinder is required, and if so, to determine and effect the appropriate adaptive adjustment to the operation of the grinder (e.g., speed, grind time, etc.), and therefore, the grind size. As with the example described above, one or both of these determinations may be made using, for example, one or more empirically-derived profiles or other metrics that take into account one or more of the monitored parameters (i.e., in the same manner described above with respect to using a weight/time profile) and/or one or more data structures, such as, for example, one- or multi-dimensional look-up tables that relate to one or more of the monitored parameters.

In any event, and regardless of the particular parameter(s) that are taken into account, the grinder may be adjusted to adjust the size of the grounds produced thereby. For example, and with respect to the exemplary embodiment illustrated in FIG. 8, the worm gear 120 and motor 122 may be used to drive an adjustment cam to adjust the size of the grounds produced by grinder unit 116. For example, as the motor is engaged in one direction or the other, the grind size may be adjusted by rotating a collar on a threaded collar. The grinding plate attached to this collar may be raised or lowered, which may ultimately increase or reduce the grind size, respectively. In order to ensure, for example, that the correct adjustments were made to the grinder and/or to determine the actual size of the grounds being produced by the grinder, in an exemplary embodiment, the grind size of the grounds being produced by the grinder may be measured. In such an embodiment, the grinder may include one or more sensors (e.g., ultrasound transducers) that are configured to measure or detect the size of the grounds being produced and those measurements may then be used to adjust, or further adjust, the grind size, if needed. Alternatively, or in addition, if it is determined, based on the measured grind size, that the operation of the grinder is acceptable (e.g., the grind size is correct or at least within a predetermined tolerance range), or conversely that the operation of the grinder is unacceptable (e.g., the grind size is unacceptably inaccurate), that information may be logged and potentially used to initiate corrective measures (e.g., shutting down the grinder, scheduling a service call, etc.).

As was described above, other process or operational parameters of an extraction/expression process that may be adjusted relate to the tamping of the grounds used in the extraction/expression process. For example, based on one or more parameters including, for example, those described elsewhere herein, as well as one or more additional parameters such as, for example and without limitation: the type, amount, and/or other characteristics of the grounds to be used; the type of beverage being produced; and the overall number of layers to be formed for the puck and the current layer to be tamped; one or more operational parameters relating to the tamping process may be adjusted to ensure optimal and efficient performance of an expression process and optimal quality of the end product. These operational parameters may include, for example, the amount of time the grounds are tamped (e.g., tamp time) and the amount of pressure or force applied to the grounds being tamped (e.g., tamp pressure), to name a few.

Accordingly, using the same or similar techniques described above with respect to the adaptive adjustment of grind size, one or more parameters, conditions, or characteristics relating to, for example, the performance of an extraction/expression process may be taken into account to determine if an adaptive adjustment should be made to one or more operational parameters of a tamper unit (e.g., tamper unit 122), and if so, to what degree. Based on that/those determinations, the performance and operation of the tamper unit may be controlled accordingly (e.g., to increase/decrease tamp time, tamp pressure, or some other operational parameter) to effect the determined adjustment(s).

For example, if it is determined that an expression/extraction process for an espresso shot is taking (or has taken) too long to complete or, conversely, was completed too fast, the tamp time or pressure may be adjusted accordingly in order to either shorten or lengthen the extraction or expression time for the next espresso shot. Similarly, if a certain known amount and/or type of grounds are introduced into a chamber of the brew tube (e.g., chamber 98 of brew tube 96), that particular amount and/or type of grounds may be taken into account or consideration in determining a particular tamp time to be employed (e.g., look up the amount of grounds in a data structure, for example, that correlates such a parameter with tamp time), and the tamper unit may be controlled accordingly. It will be appreciated that any number of parameters, conditions, characteristics and/or one or more combinations thereof relating to, for example, the grounds in the chamber, the characteristics of various components performing the process or portion thereof, environmental parameters/conditions, etc., may be used in determining an appropriate tamp time to be employed, or making determinations relating to other operational parameters of a tamper unit (e.g., tamping pressure). Accordingly, the present disclosure is not intended to be limited any one particular parameter to be evaluated or any one particular operational parameter to be controlled. It will be further appreciated the same or similar process may be employed in determining or selecting values for one or more operational parameters from a plurality of corresponding values, as opposed to “adjusting” existing operational parameter values.

It will be appreciated that with respect to system 10, in an exemplary embodiment, the functionality described above relating to the adaptability and profiling of various processes performed in the generation of a beverage may be performed in whole or in part by one or combination of ECU 18, another component of kiosk 12, and/or central host 14. Accordingly, the present disclosure is not intended to be limited to any one scheme or arrangement.

As described above, depending on the particular beverage being produced, another step in the production process may include dispensing one or more additives. More particularly, certain beverages produced by kiosk 12 may include ingredients in the form of additives such as, for example, flavored syrup, dairy (e.g., cold or steamed milk), sweeteners, water, etc. These additives may be refrigerated (e.g., in the case of dairy) or non-refrigerated, and may be stored in and dispensed from one or more process modules 20 (e.g., finisher units 42).

In an exemplary embodiment, ECU 18 is configured to control the dispensing of these additives in accordance with predetermined recipes that calling for one or more additives, as well as particular and precise amounts thereof. ECU 18 may be configured to dispense all of the additives for a given beverage at once, or one additive at a time. In either instance, ECU 18 may be configured to control the amount of each type of additive in a number of ways. One exemplary way is by monitoring the weight of the cup or container into which the additives are dispensed using an electronic weight measuring device, such as, for example, a load cell, that is electrically connected to ECU 18. For example, if additives are added one at a time, as each additive is added, the ECU 18 may monitor the weight of the cup and when the weight of the cup changes a predetermined amount, ECU 18 may stop the dispensing of that additive. Similarly, when the additives are all added at once, ECU 18 may monitor the weight and when the weight reaches a predetermined amount, cease the additive dispensing process. In an exemplary embodiment, if it is determined by monitoring the weight of the cup that too much additive has been added, the cup may be discarded and adjustments to the dispensing process made. In an instance where two or more additives are added at once and it is determined that too much of one or more additives were dispensed, each process module corresponding to those additives may be tested and adjusted accordingly. One way adjustments may be made to the additive dispensing process is to adapt the performance thereof to one or more environmental parameters (e.g., temperature, humidity, barometric pressure, etc.), operational parameters of kiosk 12, and/or characteristics of the additives themselves (e.g., viscosity, temperature, volume in a container, hose size, etc.). This may be accomplished using appropriate process profiles or other metrics in a similar manner or fashion to that described above with respect to an expression process (i.e., the adaption of grinding and tamping processes).

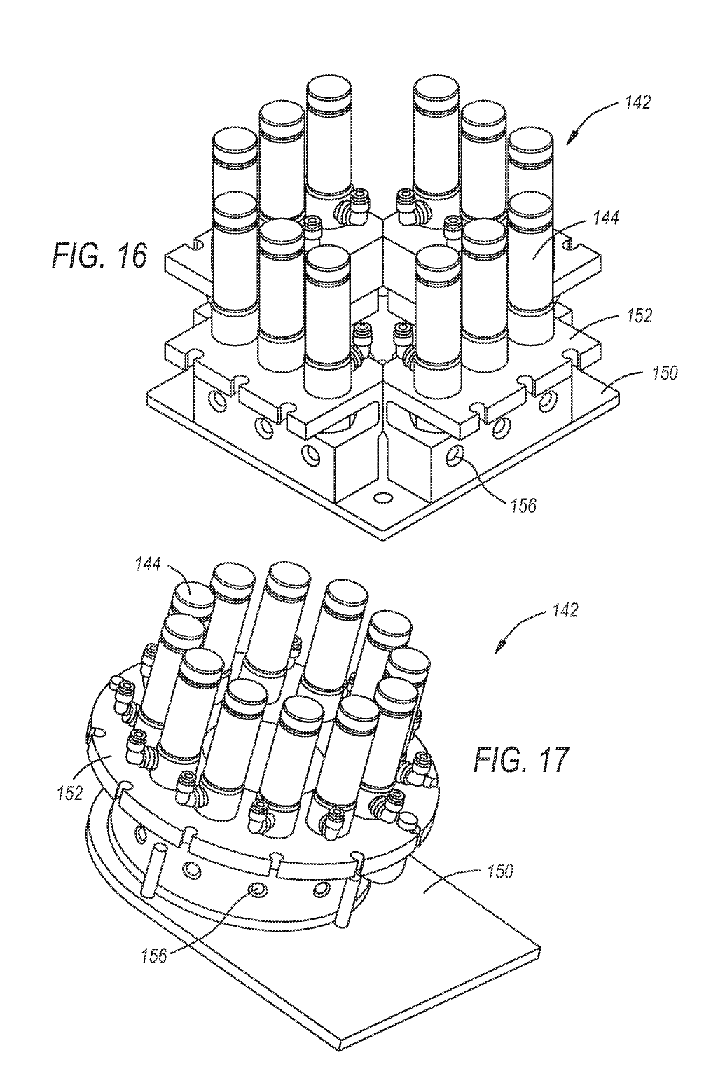

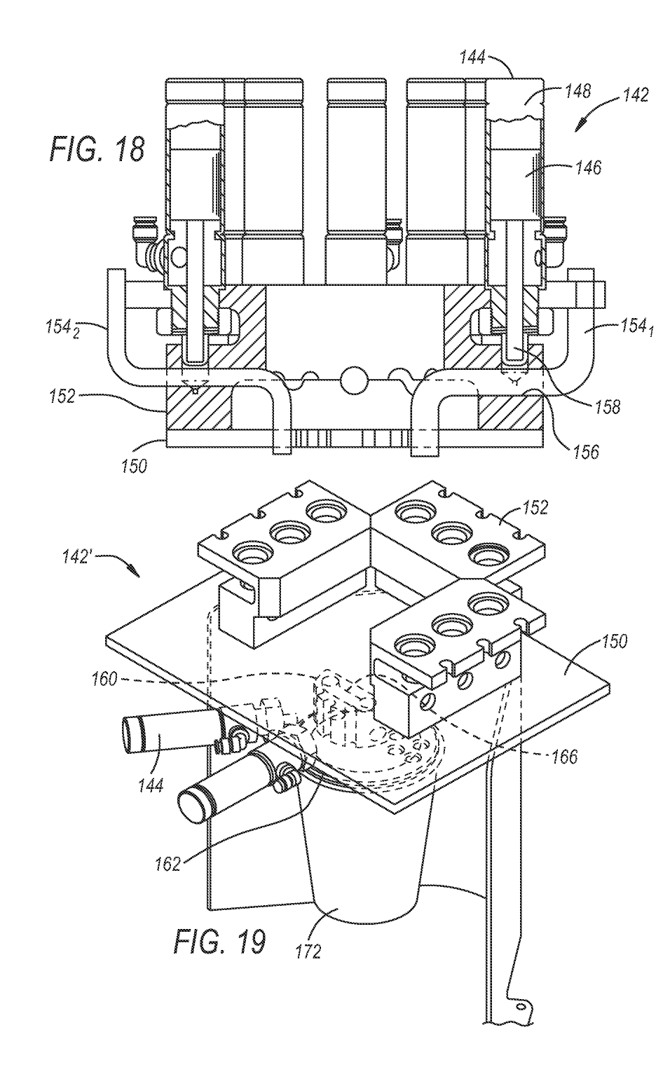

With reference to FIGS. 16-21, one way in which the dispensing of additives may be controlled is by controlling one or more valves that form a valve assembly 142 wherein each valve 144 thereof corresponds to a respective process module 20 or additive storage container. An exemplary type of valve 144 is a pneumatically actuated pinch valve comprising a spring loaded plunger 146 that is configured to travel within a corresponding cylinder 148 (best shown in FIG. 18). It will be appreciated that while the description below will be primarily with respect to a pinch valve, the present disclosure is not meant to be so limited. Rather, in various embodiments, any number of suitable valves other than pinch valves may be used, and such valves remain within the spirit and scope of the present disclosure.

Valves 144 of valve assembly 142 may be arranged in a number of ways. In an exemplary embodiment, one or more valves 144 may be disposed in close proximity to each process module 20 containing a liquid additive (e.g., below the process module). In such an embodiment, when a beverage requires a certain additive, the container (e.g., cup) in which the beverage is being produced may be moved to the location where that additive is dispensed, and the valve may then be controlled to dispense the additive. In other exemplary embodiments, such as, for example, those illustrated in FIGS. 16-21, valve assembly 142 may comprise a centrally located valve assembly such that hoses or tubes extend from each process module 20 to a respective valve 144 of valve assembly 142. In such an embodiment, when a beverage requires an additive, the container (e.g., cup) in which the beverage is being produced may be moved to the location of the valve assembly and then one or more additives may be dispensed into the container without moving the cup.

FIGS. 16 and 17 each depict an exemplary embodiment of a centrally located valve assembly 142. In these embodiments, valve assembly 142 comprises a mounting plate 150, one or more valve supporting blocks 152 mounted to the top side of mounting plate 150, and one or more valves 144, such as, for example, pinch valves, each supported by a supporting block 152. In the embodiment illustrated in FIG. 16, each block 152 is configured such that the valves associated therewith are linearly arranged. In the embodiment illustrated in FIG. 17, a single block 152 is provided and is configured such that the valves 144 associated therewith are arranged in a radial fashion. Other than the particular arrangement of the valves 144, the functionality of each embodiment of valve assembly 142 illustrated in FIGS. 16 and 17 is the substantially the same, and is best illustrated in, and will be described below with respect to, FIG. 18.

Accordingly, with reference to FIG. 18, each hose 154 (e.g., hoses 154₁, 154₂) extending from a process module 20 containing an additive is fed through a channel 156 in block 152 and down to a central area below mounting plate 150 that may be directly above an area where a cup into which additives are to be dispensed would be disposed (e.g., the cup may be on a load cell to allow for the measurement of the additives being dispensed). One or more channels 156 have a valve 144 corresponding thereto that includes a spring-loaded piston or plunger 146, an end 158 of which is configured to extend into the channel 156 when the corresponding valve 144 is in a disengaged or deactivated state. More particularly, when no air is supplied to the cylinder 148 of the valve 144, plunger 146 is forced towards channel 156 (e.g., downwardly) by the spring of the valve 144, which causes end 158 to project into channel 156. Alternatively, when the valve 144 is actuated and air is supplied to the cylinder 148, the air pressure overcomes the force of the spring, thereby causing the plunger 146 to move within the cylinder 148 in a direction that is away (e.g., upwardly) from channel 156, which results in end 158 of plunger 146 moving out of channel 156. Accordingly, when a hose 154 is disposed within a channel 156, and the additive corresponding to that hose is not needed, the plunger extends into the channel and pinches the hose, thereby preventing the additive from being dispensed. If, on the other hand, the additive corresponding to that hose is needed, the valve is actuated (e.g., an air source of kiosk 12 injects a sufficient amount of air into the cylinder of the valve), causing the plunger to move away from and out of channel 156, thereby allowing the additive to flow through and out of the hose until it is determined that enough additive has been dispensed, at which time the hose is once again pinched. It will be appreciated that while the description above is with respect to the functionality of a pinch valve in the context of a centrally-located valve assembly, the same functionality may apply to an embodiment such as that described above wherein a valve is disposed at each process module 20.

In an exemplary embodiment, the valve assembly 142 described above may be used for dispensing both refrigerated and non-refrigerated additives. However, in another exemplary embodiment, it may be desirable to maintain the refrigeration or cooling of refrigerated additives from a refrigerated compartment of the process module 20 all the way to the pinch point or dispensing point at the valve assembly. FIGS. 19-21 illustrate an exemplary embodiment of valve assembly 142 (i.e., valve assembly 142′) that is configured to accommodate both non-refrigerated additives and refrigerated additives that are constantly cooled or refrigerated through the pinch point of the corresponding hoses.

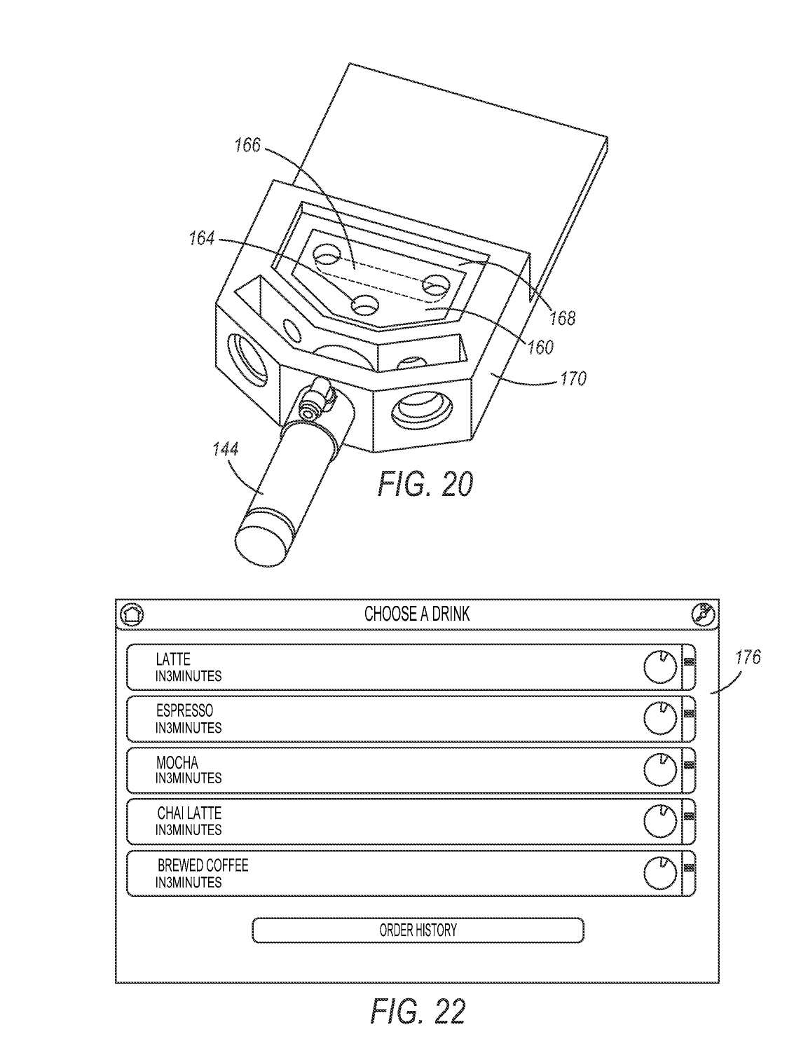

With reference to FIG. 19, and as with the embodiments illustrated in FIGS. 16-18, valve assembly 142′ comprises mounting plate 150, one or more valve supporting blocks 152 that are mounted to the top side of mounting plate 150, and one or more pinch valves (not shown) each of which is supported by a supporting block 152. In addition, however, valve assembly 142′ further comprises a cooling block 160 that, in an exemplary embodiment, is mounted to a second mounting plate 162 disposed below mounting plate 150 and directly above an area where a cup into which additives are to be dispensed would be disposed, and one or more additional pinch valves 144 associated with the cooling block 160. With reference to FIG. 20, cooling block 160, which in an exemplary embodiment comprises a thermo-conductive material, such as, for example, aluminum, may include a plurality of channels 164 extending therethrough, each of which is configured to receive a hose 154 corresponding to a refrigerated additive. Cooling block 160 further includes one or more passageways 166 through which a coolant or refrigerant, such as, for example, glycol, may be circulated to cool cooling block 160. In certain embodiments, cooling block 160 may further include an insulator 168 (best shown in FIG. 20) that, for example, minimizes condensation, and/or an outer frame 170 constructed of, for example, a metal material such as aluminum or stainless steel, which also supports one or more valves 144 such that it serves the same purpose as the valve supporting blocks 152 illustrated in FIGS. 16 and 17.

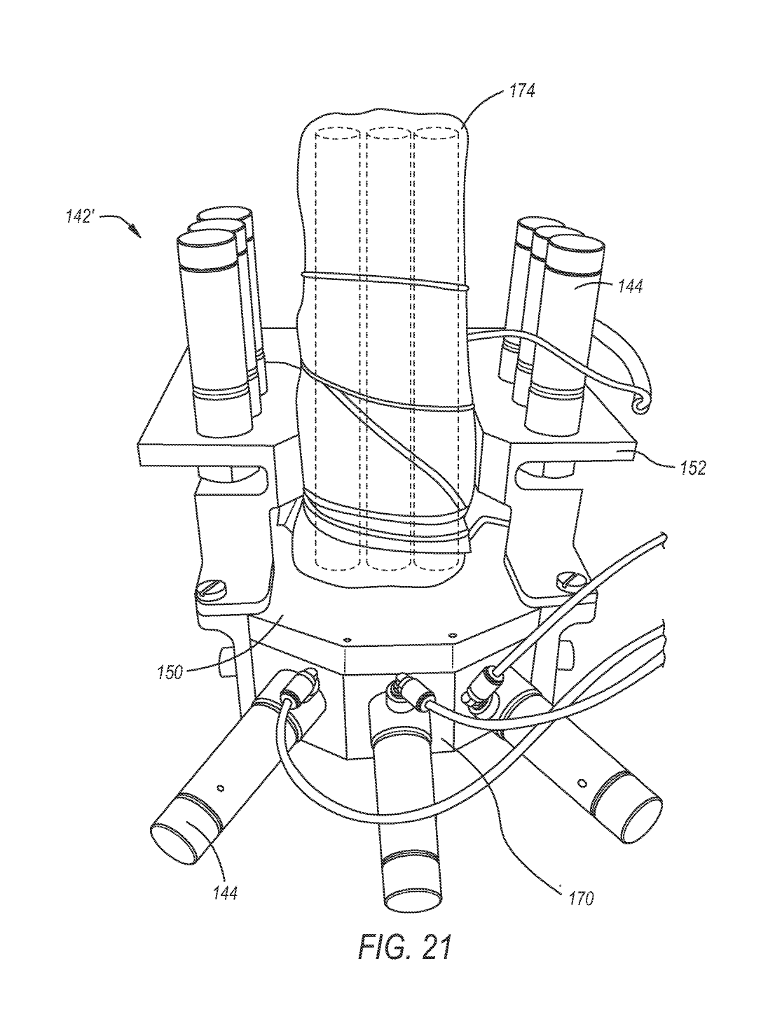

In an exemplary embodiment, the valves 144 corresponding to non-refrigerated additives may function in substantially the same manner as that described above, and therefore, the description above applies here with equal weight and will not be repeated. With respect to the refrigerated additives, in the embodiment illustrated in FIGS. 19-21, each hose extending from a process module 20 containing a refrigerated additive is fed vertically through a corresponding aperture in mounting plate 150, a channel 164 in cooling block 160, and down to a central area below mounting plate 162 that may be directly above an area where a cup 172 into which additives are to be dispensed would be disposed. In an exemplary embodiment, those hoses containing refrigerated additives may be grouped together in a refrigerated bundle, such as, for example, bundle 174 illustrated in FIG. 21.

As with channels 156 of supporting blocks 152 described above, each channel 164 of cooling block 160 may have a valve 144 corresponding thereto that includes a spring-loaded piston or plunger 146, an end 158 of which is configured to extend into the channel 164 when the valve is in a disengaged or deactivated state. More particularly, and as was described above, when no air is supplied to the cylinder 148 of a valve 144 plunger 146 disposed therein is forced towards the channel 164 by the spring of the valve, which causes end 158 to project into channel 164. Alternatively, when the valve is actuated and air is injected into cylinder 148, the air pressure overcomes the force of the spring, which causes the plunger 146 to travel within the cylinder 148 in a direction that is away from channel 164, thereby resulting in end 158 of plunger 146 moving out of channel 164. Accordingly, when a hose 154 is disposed within a channel 164 and the additive corresponding to that hose is not needed, the plunger 146 extends into the channel 164 and pinches the hose 154 against the cooling block 160, thereby preventing the additive from being dispensed while also maintaining the cooling of the additive in the hose. If, on the other hand, the additive corresponding to that hose is needed, the valve is actuated causing the plunger to move away from and out of channel 164, thereby allowing the additive to flow through and out of the hose until it is determined that enough additive has been dispensed, at which time the hose is once again pinched. It will be appreciated that while the description above is with respect to the functionality of a pinch valve in the context of a centrally-located valve assembly, the same functionality may apply, for example, to an embodiment such as that described above wherein a valve is disposed at each process module.

It will be appreciated that while FIGS. 19-21 illustrate an exemplary configuration of valve assembly 142′ wherein the valves corresponding to refrigerated additives are arranged horizontally and the valves corresponding to the non-refrigerated additives are arranged vertically, the present disclosure is not meant to be so limited. Rather, in other exemplary embodiments, the different valves for the different types of additives may be arranged in any number of configurations, each of which remains within the spirit and scope of the present disclosure.

In addition to the above, in some embodiments of system 10, and kiosk 12, in particular, a cleaning process may be employed for cleaning various components of one or more process modules, such as, for example, the expressor units (e.g., espresso unit 40) described above. In various embodiments, the cleaning process may be performed simultaneous with the performance of one or more chemical or mechanical processes that contribute to the production of a beverage, or alternatively, may be performed only when no other processes are being performed. One exemplary cleaning process is a clean-in-place (CIP) process as described in U.S. Patent Publication No. 2012/0156337, which was incorporated herein by reference above, and which will be briefly summarized below with respect to espresso unit 40. Accordingly, in an exemplary embodiment, various components of espresso unit 40, including, for example, chambers 98, 100 and filter 102 of brew tube 96 that are illustrated in FIGS. 8-12 may be cleaned using such a CIP process.

In an exemplary embodiment, first chamber 98 of brew tube 96 may be cleaned by first aligning chamber 98 with one or more components required to perform the cleaning process and to facilitate the expelling of the coffee puck 110 disposed therein. For instance, in one example, the apparatus configured to perform the cleaning process is disposed directly below brew tube 96. In such an embodiment, in order to clean chamber 98, brew tube 96 may be rotated 180° to align chamber 98 with the cleaning apparatus. Once aligned, water or some other cleaning solution is then introduced into chamber 98 and, in certain embodiments, ultrasound waves are applied for the same purposes described above. In an exemplary embodiment, filter 102 of brew tube 96 may also be cleaned using, for example, a combination of a backflow of fluid (e.g., water or a suitable cleaning solution) and an application of ultrasound waves to dislodge any particles (e.g., coffee grounds) and flush them away.

In some embodiments, the cleaning process may be carried out in two or more phases, with the final phase being performed immediately before the next brewing cycle in order to achieve both the cleaning effect and to pre-heat chamber 98 of brew tube 96 for the next brewing cycle. In an exemplary embodiment, the cleaning process may make use of a cleaning chamber that is common to, for example, a number of components of various process modules. For instance, in an exemplary embodiment, the cleaning chamber is common to a steam wand of a frothing module, brew tube 96, and potentially various additive dispensers. The cleaning chamber may be on a rotating plate or an XYZ actuator that may be controlled (e.g., by ECU 18) to move it into place to perform a cleaning process. The cleaning chamber may include one or more spraying jets that pre-spray the object being cleaned at an angle while filling the cleaning chamber with water or a suitable cleaning solution and/or creating turbulence to aid in the cleaning process. In other words, the cleaning process may include a spraying process, turbulence, and/or ultrasonic processes. In some embodiments, the cleaning chamber and other components of kiosk 12 may use the same actuator and/or may be co-located on the same rotating plate or XYZ actuator.

In an exemplary embodiment, ECU 18 may be configured to manage the cleaning process briefly described above. In various embodiments, each process module 20 of kiosk 12 may require periodic self-washing and/or self-cleaning. ECU 18 may be configured to determine whether there is an upcoming requirement to clean a particular element (e.g., expressor unit) between functional cycles. For example, when there is a gap in demand from customers, or when a gap in production is created as a result of a phantom beverage order being placed by ECU 18 or central host 14 to allow such maintenance, ECU 18 may direct that a particular process module 20 should be cleaned.

Additionally, in an exemplary embodiment, the same cleaning process and structure or equipment required to perform the same may be a shared resource in that it may be used to clean different components of different process modules. For example, in an exemplary embodiment the cleaning process may be configured to clean components of an expressor unit, as described above, as well as to clean components of, for example, a frothing unit (e.g., chambers, steam wands, etc. thereof) or some other process module 20.

Interfacing and Communicating with Users

In an addition to the features and functionality described above relating to the production of beverages, it will be appreciated that system 10, and the constituent components thereof, in particular, may include any number of additional features and be further configured to perform any number of additional functions, such as, for example, interfacing and communicating with users in various ways. More particularly, system 10 may be configured to allow users such as, for example, service technicians, operations personnel, administrators, customers, and potential customers, to name a few, and one or more components of system 10 (e.g., kiosk 12, central host 14, etc.) to interface, communicate, and in certain instances, interact with each other for a variety of purposes, some of which will be described below. This communication (whether one-way or two-way) and/or interaction may be facilitated at least in part by one or more user interfaces, such as, for example, user interfaces 16, 22 described above and illustrated in FIG. 1.

It will be apparent from the description above that one purpose of allowing users to interface and communicate with system 10 is to facilitate the placement of orders for beverages and, if applicable, other goods that may be offered at a particular kiosk 12. Orders may be placed and processed in a number of ways, such as, for example, directly at a particular kiosk, or alternatively, through central host 14.

With respect to the first instance where orders may be placed directly at kiosk 12, such orders may be placed in a variety of ways. For example, kiosk 12 may include a user interface 16, such as, for example, touch screen 54 illustrated in FIG. 3, that is configured to display one or more user-inputtable or user-selectable fields or links thereon to facilitate the ordering process. In such an embodiment, ECU 18, or some other suitable component, may be configured to control the user interface 16 to display such fields or links thereon. A customer may then interact with the user interface 16 to place and, if applicable, customize an ordered beverage. In another embodiment, orders may also or alternatively be placed directly at kiosk 12 using, for example, one or more user interfaces 22 that is/are not part of kiosk 12, per se. More particularly, in an embodiment wherein a user device, such as, for example, a smart phone, personal computer, etc., and a component of kiosk 12, such as, for example, ECU 18, are both connected to a local network (e.g., Wi-Fi, Bluetooth, etc.), a user interface 22 in the form of one or more graphical or text-based interfaces generated by, for example, application software stored on the user device, may be displayed thereon and used to facilitate the ordering process.

Regardless of which method described above is used to place an order locally at a kiosk, in an exemplary embodiment, the ordering process is the same. For example, FIG. 22 depicts a representation of a graphical user interface (GUI) 176 that may be used to select a desired beverage from among a plurality of different beverage options. The beverage options may include standard beverages produced by the kiosk or, in certain instances, may include a list of beverages that a customer has indicated are his favorites or that he has recently ordered. In any event, the customer may interact with the GUI to select a particular beverage. In an exemplary embodiment such as that illustrated in FIG. 22, in addition to displaying a list of beverage options, the GUI may also provide additional information such as, for example, an indication as to the amount of time that it will take to produce certain beverages, information that may factor into a customer's decision.

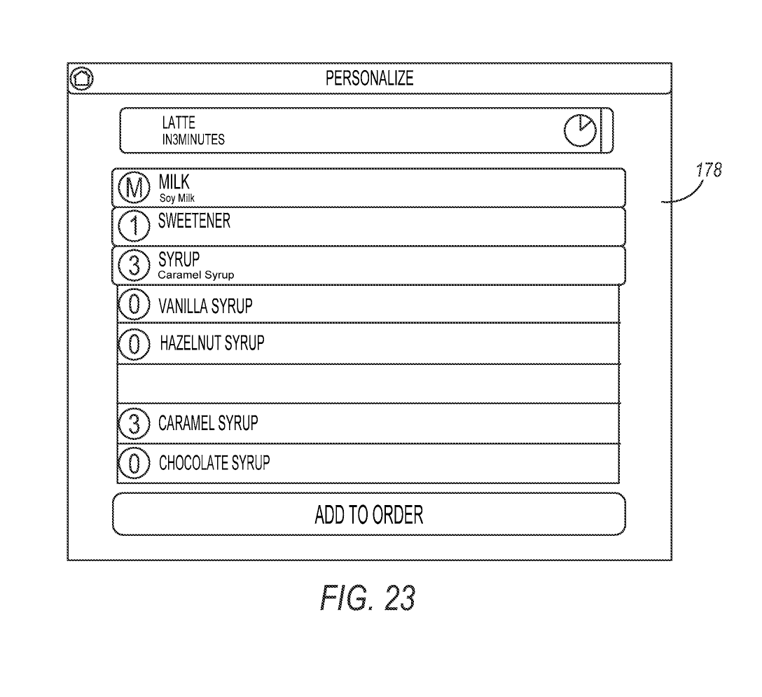

Once a particular beverage has been selected as described above, in certain embodiments, a customer may be permitted to customize or modify the ordered beverage. In such an instance, this may be accomplished through a GUI such as, for example, GUI 178 illustrated in FIG. 23. Accordingly, as shown in FIG. 23, GUI 178 may present a customer a number of selectable customization options, including, for example, various additives or ingredients that may be added to, or used in the production of, the beverage from which the customer may make one or more selections. It will be appreciated that in certain instances, the beverage may be further customized by allowing a customer to select particular amounts or specific types of additives to be added to, or used in the production of, the beverage, as well as to make selections relating to other parameters of the beverage, such as, for example, a temperature the customer would like the beverage to be at when it is presented to him. In an exemplary embodiment, GUI 178 may also provide additional information, such as, for example, information relating to the different additives that may be selected (e.g., age, brand, nutritional facts, etc.) to assist the customer in his selections.

Whether or not an ordered beverage may be customized, once a customer has completed his order, it may be sent to ECU 18 which may then either immediately initiate the production of the ordered beverage (i.e., by controlling one or more process modules 20, for example), or, as will be described below, may cause the order to be entered into a production queue maintained and managed locally at kiosk 12, in which case the initiation of the production of the ordered beverage may be delayed until a particular time in the future.

As briefly described above, another way in which orders may be placed or processed is through central host 14 when a user is located remotely from a kiosk and outside of the range of a local network corresponding thereto. More particularly, and as is known in the art, customers may interact with central host 14 using user interfaces 22 in the form of one or more GUIs or text-based interfaces, for example, generated by application software and displayed on a user device, such as, for example, a personal computer, a smart phone, a tablet, and/or other suitable devices. These one or more interfaces, which may take the form of those illustrated in FIGS. 22 and 23, may then be used by a customer to make various selections relating to, for example, the desired beverage and the customization of the beverage in the same manner described above. In certain embodiments, the customer may be further allowed to make additional selections relating to, for example, the particular kiosk and/or time at which he would like to pick-up the beverage. In an exemplary embodiment, information that may assist the customer in making various decisions may be provided to the customer by system host 14 through one or more user interfaces 22. This information may include, for example, the respective distances between the customer's current location and different kiosks, wait times at different kiosks, information relating to the ability of a particular kiosk to produce the desired beverage and/or to do so in accordance with the customer's desired pick-up time, information related to traffic conditions in the area of one or more kiosks, etc.

In any event, once the customer has completed his order, it is communicated to central host 14. Central host 14 may then relay the order to the appropriate kiosk at which the customer will pick-up his beverage along with, in certain embodiments, specific information relating to the order (e.g., recipes to be used, time at which to produce the beverage, customer identifying information, etc.). In addition relaying the order to the appropriate kiosk, in an exemplary embodiment, central host 14 may be further configured to store specific information relating to the order in a database. This information may include, for example, that relating to the customer as well as information relating to the particular kiosk to which the order was sent. That information may then be relayed to the kiosk 12 so that kiosk 12 may update its locally stored data/information.

It will be appreciated that while certain functionality relating to the placement of orders through one or more user interfaces has been described above, the present disclosure is not meant to be limited solely to such functionality and/or the particular implementations thereof. Rather, it will be appreciated that in various embodiments, additional functionality and/or alternate implementations of the functionality described above may be included, such as, for example, that or those described in U.S. Patent Publication No. 2012/0156337 incorporated herein by reference above, and therefore, such functionality and implementations remain within the spirit and scope of the present disclosure.

In addition to the order submission and processing functionality described thus far above, in various embodiments, and regardless of whether orders are placed locally (e.g., through a user interface 16 or, in certain instances, a user interface 22) or remotely (e.g., through a user interface 22) through central host 14, central host 14 and/or kiosk 12 may be configured to perform additional functionality, including, for example, functions that may be performed during the order placement process, during the production of a beverage ordered by the customer, or at any other time. This functionality may be performed at least in part through or by one or more user interfaces of kiosk 12 or system 10, such as, for example, one or more of user interfaces 16 and 22.

For example, in certain instances information relating to the availability of seats in a seating area in the vicinity of a particular kiosk may be provided to a customer. More particularly, kiosk 12, and in an exemplary embodiment, ECU 18, in particular, may be configured to determine whether there is available seating in a seating area that is adjacent thereto. This may be accomplished by, for example, using a camera that is configured to acquire or generate images of the seating area and to provide those images to ECU 18, or another suitable component of kiosk 12. By processing the acquired images using known image processing techniques, it may be determined whether there is seating available, and this information may be provided to the customer through a user interface. In an exemplary embodiment, the additional functionality of allowing a user to reserve one or more seats in a seating area if, for example, the customer is within a certain distance or time from the kiosk, may also be included.

In another exemplary embodiment, kiosk 12, and ECU 18 or another suitable ECU, in particular, may be configured to create and manage a beverage production queue (also referred to as a “virtual queue”) for that particular kiosk. Accordingly, in an exemplary embodiment, all requests for the production of one or more brewed beverages corresponding to that kiosk, regardless of whether received locally or remotely, are placed in a queue by, for example, ECU 18, and then ECU 18 works from that queue in producing beverages. In an exemplary embodiment, rather than constructing and managing the queue strictly on a “first in, first out” or “first come, first served” basis, the virtual queue described herein is constructed based on, among potentially other factors, the time at which the beverage in the queue is to be delivered to the customer. The delivery time may be based, for example, on a customer-specified delivery time, or alternatively, may be based on other parameters such as the availability of resources in the kiosk and the pipelining and traffic engineering of one or more processes (e.g., brewing process) performed in the kiosk. Once the queue is created by kiosk 12, it may be periodically sent to central host 14 where it may be stored for various purposes.

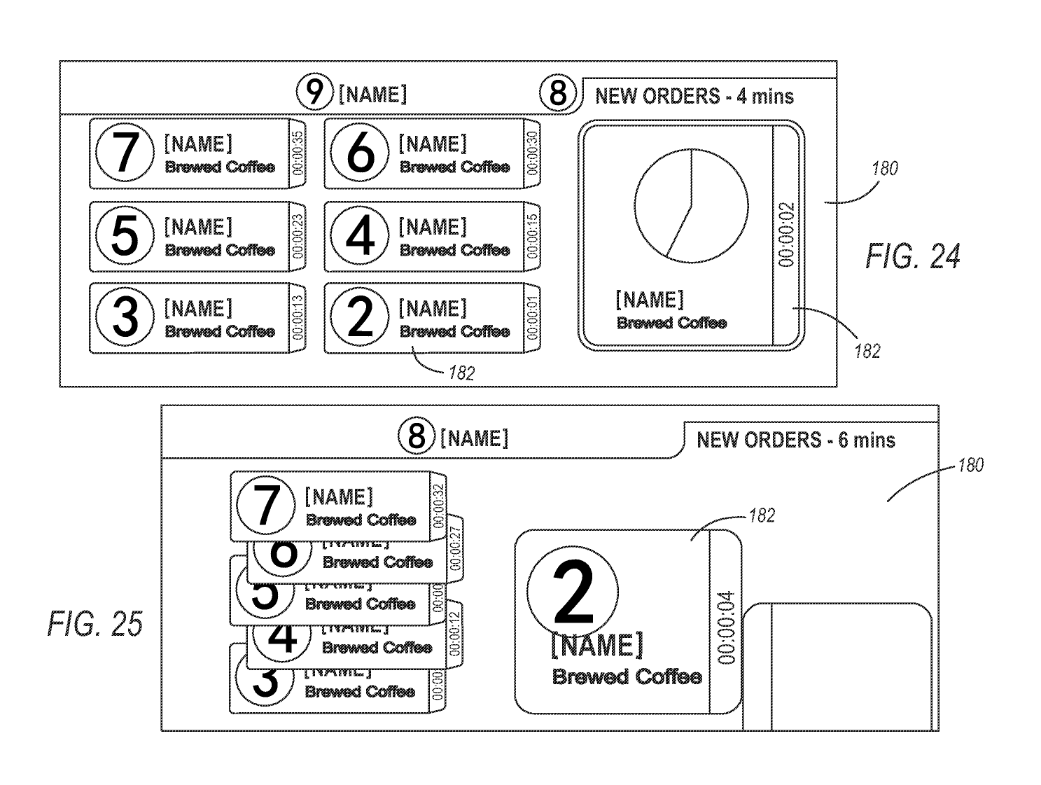

In an exemplary embodiment, the virtual queue described above may be displayed on one or more user interfaces, such as, for example, one or more of user interface(s) 16 and/or user interface(s) 22, so that a customer who has placed an order can see where his order is in the queue, and a potential customer may be able to see how busy a particular kiosk is. Accordingly, in an exemplary embodiment, one or more of kiosk 12 (e.g., ECU 18) and central host 14 (in an instance wherein the queue is stored at central host 14) may be configured to generate a representation of the queue and to cause it to be displayed on a user interface (e.g., user interfaces 16, 22). In an exemplary embodiment, along with displaying the individual beverages in the queue, an indication may also be provided for one or more of the beverages as to how long it will be before the beverage is completed, and/or what stage of the production process the beverage is currently in. A customer identifier for each beverage in the queue may also be displayed so that a customer knows which beverage is theirs. It will be appreciated that the queue may be displayed or represented in a number of ways. For example, in the embodiment illustrated in FIG. 24, the queue (i.e., queue 180) may be represented by a plurality “bubbles” 182 (each corresponding to a respective beverage in the queue). In an exemplary embodiment, and as illustrated in FIG. 25, the representation of queue 180 may be dynamic in the sense that these bubbles 182 may move as their place in the queue changes, and/or as the beverage moves among different stages in the corresponding production process.

In addition to the above, in an exemplary embodiment, customers may have the ability to purchase or sell places in the queue that correspond to beverage delivery times. This may be accomplished in a number of ways. For example, a customer who is ordering a beverage may be offered the opportunity to purchase a particular position (e.g., a delivery time) in the queue (e.g., a higher or lower priority position, or earlier or later delivery time, than that which the customer is in or would be in once his order is placed or a different, earlier or later, time to receive his beverage). Such an offer may be displayed on the user interface the customer is using to place their order, and may be an option the customer may select when making other selections relating to their beverage, such as, for example, selecting a beverage, customizing the beverage, selecting a delivery time and/or a particular kiosk, etc., or as part of a “check out” or order confirmation process. Alternatively, during the ordering process, the customer may be able to see a representation of the current state of the queue for one or more kiosks, which may contain one or more indicators that one or more queue positions or times are available for purchase. Additionally, or alternatively, a customer may also be permitted to purchase a different position after his order has been entered into the queue, and this may be accomplished through, for example, a user interface on which a representation of the queue is displayed, such as, for example, that illustrated in FIGS. 24 and 25.

In the event a customer wishes to purchase a particular queue position, the customer may indicate his desire to do so through the user interface, and his intention may then be communicated to one or both of kiosk 12 (e.g., ECU 18) and central host 14, which then may adjust the queue accordingly. The corresponding cost or price to purchase the new position may either be added to the price of the customer's beverage, or may be paid in another financial transaction apart from that relating to the payment for the beverage itself (e.g., a debit or credit card on file would be charged, the customer may need to pay in cash or with a credit card when the beverage is picked up, banked loyalty points may be used, etc.). Additionally, the particular price that the customer is charged may be a standard price that is set by system 10, or may be a price that is set by the customer who is selling the queue position or time that is being purchased.

In addition to providing a customer the opportunity to purchase a particular position or time in the queue for a particular kiosk, in an exemplary embodiment, a customer who does not need or want their current queue position or time may be provided the opportunity to sell their position or time. This may be accomplished in a number of ways. For example, through a user interface, a customer may indicate that his position or time in the queue is available for purchase by another customer. Alternatively, through the user interface, the customer may be notified that there is another customer who is interested in purchasing a different queue position or time, and using the user interface, the customer may indicate his interest in selling his position or time. In the event his queue position or time is purchased by another customer, the purchase may communicated to one or both of ECU 18 and central host 14, which may then adjust the queue accordingly. The customer who sold his position or time may then be compensated for the sale in a number of ways. For example, the customer may receive a credit in the amount of the sale price (or a lower amount), a gift card for the sale price (or a lower amount), the sale price or a lower amount may be deducted from the price of a yet-to-be-paid-for beverage, the customer may be granted loyalty points, or any other commercially acceptable way.

In an exemplary embodiment, another feature of system 10 relates to the provision of competitor-related information to a customer. This information, which may be provided to customers via a user interface during the beverage ordering process described above, may include, for example, information relating to wait times at one or more competitor locations and information relating to the queues at one or more different competitor locations, to name a few types. The information may also comprise information about a competitor's products (e.g., the ingredients used, process parameters utilized in producing various beverages (e.g., rate of extraction, extraction time, temperate of extraction, etc.), beverage-related parameters (e.g., temperature of completed beverages, density of foam, amounts of additives used, etc.)). This information may be acquired by kiosk 12 and/or central host 14 in a number of ways. For example, with respect to wait times at competitor locations, cameras positioned within view of one or more competitor locations may be used to capture or acquire images showing the length of the lines at those locations. Those images may then be processed using known image processing techniques to determine approximate wait times at those locations. Alternatively, if the competitor publicizes information such as wait times or other queue information, and/or information on their products, in a publicly accessible place (e.g., a website), that information may be acquired from that source. One purpose of displaying this information would be to sway a customer away from a competitor.

In an exemplary embodiment, another feature of system 10 relates to the ability to tailor a customer's order to their emotional state. For example, during the ordering process, a customer may be asked what their current emotional state is and then based on their response, adjustments or modifications can be made to a beverage that the customer orders. Alternatively, suggestions can be made as to particular beverages that the customer may want based on how they are feeling. More particularly, in an exemplary embodiment, kiosk 12 (e.g., ECU 18) and/or central host 14 may be configured to log both the beverages ordered by a particular customer and that customer's emotional state when those beverages were ordered. Using that information, a pattern or correlation between beverage and emotional state may be determined and, in certain embodiments, used to suggest a given beverage when that customer indicates a particular emotional state. For instance, if a customer typically orders “Beverage A” when they are happy, the next time the customer indicates that he is happy, he may be prompted with the question of “would you like to order Beverage A?”, or Beverage A may simply be suggested to the customer. In another exemplary embodiment, one or more modifications may be made to a beverage in response to a particular emotional state. For example, if the customer indicates he is tired, the caffeine content of the beverage he orders may be adjusted accordingly.

As briefly mentioned above, in various embodiments, certain functionality other than that described above may be performed during the production process of a beverage. For example, messages or information may be provided to a customer during the production process corresponding to their ordered beverage(s). For example, in an exemplary embodiment, messages or other information specifically tailored to a particular customer may be displayed on a user interface (e.g., user interfaces 16, 22, for example) to apprise the customer of the status or progress of their order. Accordingly, if during the production of a particular beverage, the beverage moves from one stage of the production process to another, that progress may be indicated on a user interface accessible by the customer. Similarly, when the production process for a beverage has been completed and the beverage is ready to be picked up, the temperature of the beverage may be measured and displayed on a user interface accessible by the customer. In such an embodiment, a temperature sensor disposed within or under the cup may be configured to measure or detect the temperature of the beverage, and to report back to one or both of ECU 18 and central host 14. The measured or detected temperature may then be displayed for the customer to see. One purpose for displaying this information is that if a customer is delayed in picking up his beverage or determines that the beverage is either too hot or too cold, he may effectively cancel the order and re-order his beverage. In such an instance, the already completed beverage would be discarded. Messages and information (collectively “messages”), such as, for example, those described above, and/or any other similar messages, may be delivered in a number of ways.

For example, in an exemplary embodiment, the status or progress of an order may be communicated to the customer by visually displaying, on a user interface accessible by the customer, a two- or three-dimensional simulated barista that is made to appear as if they are performing the process currently being performed. In addition, other visual (e.g., animations), audio (e.g., sounds corresponding to the various processes), and/or aromatic (e.g., aroma, either actual or synthetic/simulated), outputs associated with the beverage production process may also be utilized in order to best emulate what the kiosk is doing. In such an embodiment, kiosk 12 (e.g., ECU 18) and/or central host 14, as the case may be, may be configured to access some or all of the specific content to be displayed from either a memory or other storage associated therewith, from a content server, or from any other suitable source, and to display that content accordingly.

In another exemplary embodiment, the messages may be delivered in accordance with a particular theme corresponding to either the kiosk 12 or to the particular customer to whom the message(s) is/are directed. These themes may relate to, for example, specific geographic locations; topics of interest, such as, for example, sports or other activities, genres of movies and/or television shows, genres of music, particular celebrities, etc.; and the like.

More particularly, in an exemplary embodiment wherein the theme corresponds to the kiosk itself, the kiosk may be programmed to have a particular persona (including, in certain embodiments an avatar) based on, for example, the geographic location in which it is located. In such an embodiment, the persona of the kiosk may match local customs, culture, and/or events that are important to that location, and would deliver messages in accordance with that persona. Similarly, in an embodiment wherein the theme corresponds to a particular customer, kiosk 12 (e.g., ECU 18) and/or central host 14 may be configured to associate that theme with that customer, and to use content corresponding thereto to deliver messages to that customer. For example, if a customer would like to have a particular celebrity deliver messages to him, a message advising the customer that his beverage is ready may comprise a video or sound recording of that celebrity saying “your beverage is now ready to be picked up.” In any event, in an embodiment wherein either a kiosk or a customer has a particular theme associated therewith, kiosk 12 (e.g., ECU 18) and/or central host 14, as the case may be, may be configured to access the theme-specific content from either a memory or other storage associated therewith, from a content server, or from any other suitable source and to display that content accordingly.

In another embodiment, rather than the messages or information being delivered in accordance with different themes for different customers, the same messages delivered to different customers may take the same form. For example, any time a beverage is ready to be picked-up, the same animation or other content may be used to notify the corresponding customer. In such an embodiment, kiosk 12 (e.g., ECU 18) and/or central host 14, as the case may be, may be configured to access some or all of the specific content to be displayed from either a memory or other storage associated therewith, from a content server, or from any other suitable source and to display that content accordingly.

Regardless of the form of the message, in an embodiment wherein the message is displayed or delivered to a customer using an interface that may be common to more than one customer (e.g., a user interface 16 at the kiosk), the displayed message may also include some customer identifier so that it is clear who the intended recipient is. Similarly, in an embodiment wherein the status of a beverage is included as part of a displayed representation of a queue that shows a number of orders for a number of customers, each item in the queue may include some customer identifier to indicate which order belongs to which customer.

As briefly mentioned above, in various embodiments, certain functionality other than that described above may be performed following the completion of a particular beverage production process. For example, various types of messages or information may be provided to a customer following the completion of the production process for that customer's beverage. In an exemplary embodiment, this may comprise visually displaying a message that the customer's beverage is ready on a user interface of or at the kiosk at which the customer is picking up his beverage (e.g., one or more user interfaces 16 of kiosk 12). In such an embodiment, this message may take any number of forms. For example, the message may simply be something to the effective of “Customer A, your beverage is ready!”. Alternatively, an identifier unique to the customer may be displayed, such as, for example, an order number, a nickname, an avatar, and the like corresponding to the customer. In any event, kiosk 12 (e.g., ECU 18) and/or central host 14, as the case may be, may be configured to access some or all of the specific content to be displayed from either a memory or other storage associated therewith, from a content server, or from any other suitable source, and to display that content accordingly.

In an exemplary embodiment, the user interface or display upon which such messages or information is displayed may be located in close proximity to a beverage presentation area of the kiosk (e.g., final product collection area 50 of kiosk 12). For example, in an exemplary embodiment, the interface may be disposed above, below, or beside a window or door that provides access to the presentation area. In another exemplary embodiment, the interface may be integrated into the door or window itself. In an embodiment wherein access to a presentation area is restricted by a door, window or some other barrier, the kiosk may further include a user interface mechanism that may be used to open the barrier, such as, for example, any one or more of the suitable user interfaces described above (e.g., touch screen 54, card reader 68, RFID reader 62, etc.), or any other suitable device, such as, for example, a thumb print reader, a facial recognition system, and the like.

Another function that may be performed following the completion of a beverage production process for a given beverage is the placement a design onto the cup being delivered to the customer, in addition to, or instead of, for example, a customer's name or other identifying information relating to the ordered beverage. For example, in an exemplary embodiment, kiosk 12 may have the ability to either print or engrave a design, such as, for example, an avatar onto a cup. In such an embodiment, ECU 18 (or another suitable device of kiosk 12) may be configured to control a printer mechanism to cause a design to be printed either directly onto the cup or onto a label that is then applied to the cup. Alternatively, or in addition, ECU 18 may be configured to control a laser or some other suitable etching or engraving device to etch or engrave a design directly onto the cup. In an exemplary embodiment, ECU 18 may be configured to access the specific design to be used from either a memory or other storage associated therewith, from a content server, or from any other suitable source.

Another feature of system 10 that, in reality, may be performed at any time following the placement of an order and before the delivery of the corresponding beverage, relates to cashless payment for the ordered beverage. In an exemplary embodiment, system 10 may utilize a cashless payment processing system as an alternative to paying cash at a kiosk. In such an embodiment, by utilizing standard credit cards and web-based non-card payment processors, the need for a payment gateway provider may be eliminated. Instead, point-of-sale processing may be done directly with a clearing bank agent. In an exemplary embodiment, system 10 may include fully secure software user interfaces utilizing, for example, a one-way cipher to deliver stateless payment card information to the clearing agent. The cipher allows for compliance with Payment Card Industry directives while also allowing the system to reference information stored by the agent that is important to creating a unique customer experience.

In an exemplary embodiment, the software user interface and associated card reader technology utilized to carry out the above described functionality may also give a customer the ability to set up a more extensive account containing, for example, information the customer wants the system to retain. This information may include, for example, information for the user of multiple payment cards or processors. In various embodiments, the software user interfaces may be accessed via the internet or other networks using a website interface and, in certain instances, smart phone technology, among other platforms. Some of the enhancements that the above described system may provide to a customer's experience may include, for example, the ability for the system to: recognize a returning customer when the customer slides their payment card through a card reader; display a history of beverage ordered by the customer; display favorite beverages ordered by the customer; and provide loyalty credits to a virtual account provider to each customer. Further enhancements may include, for example and among others, the ability for the system to: allow a customer to keep a credit balance on hand for future purchases; allow a customer to send gift purchases to other customers or users; allow users to access their personal account through social media; provide customers and customer service personnel to directly credit a user's account; provide complimentary drinks to loyal customers at random or as programmed events; and provide a financial audit of the customer's purchase history to the customer or the operator of system 10.

Yet another feature of system 10 that may be performed at any time following the placement of an order and before the delivery of the corresponding beverage, but typically at the time the beverage is retrieved and/or paid for, relates to what can be loosely referred to as giving the kiosk a gratuity or tip. This “gratuity” or “tip” may take a number of forms. For instance, in various embodiments, the tip may comprise an actual or simulated shot of oil or lubricant; the purchase of an idle cycle or phantom beverage or a joke; or a charitable contribution. In the event the tip involves a financial transaction, the corresponding amount of money may be added to a customer's bill or account, or may be settled using a number of techniques such as those described herein (e.g., payment of cash through the coin/bill acceptor 66 of kiosk 12; the use of a credit or debit card through card reader 68 of kiosk 12; etc.). In an exemplary embodiment, upon giving the kiosk a tip, the kiosk may be configured to provide a response in the form of a visual, audio, or aromatic output.

A further function that may be performed at any time a customer is interfacing with system 10 relates to the ability to gift or give a software application (i.e., commonly known as an “app”) to another person, such as, for example, potential customers, friends, and business associates, to name a few. In an exemplary embodiment, the software application may be given to another person by way of, for example, a Bluetooth-type card or other wireless mechanism. When the person to whom the application was given launches the application, in various embodiments the person who gave the application may receive one or more of a number of benefits, such as, for example, loyalty points, free beverages, and/or discounts on future purchases, among others.

Finally, as was also briefly mentioned above, in an exemplary embodiment, kiosk 12 (e.g., ECU 18) and/or central host 14 may be further configured to perform or cause to be performed any number of functions at any time (i.e., not limited to any one particular time (e.g., during an ordering or beverage production process or post-beverage production), but rather at any time), that relate to the interfacing and communication between a customer and the kiosk (or system).

In an exemplary embodiment, the system 10 may include a further feature relating to the attraction of customers to a particular kiosk 12. More particularly, in an exemplary embodiment, if a kiosk 12 (e.g., ECU 18 or another suitable component thereof) senses or otherwise determines that a customer or potential customer is in the immediate vicinity of the kiosk (e.g., within a certain number of feet of the kiosk), it may react by causing one or more attention grabbing actions to occur. In such an embodiment, the presence of a customer/potential customer may be detected in a number of ways. For example, kiosk 12 may be configured to detect the presence of a customer when the customer interacts with it through a user interface 16 thereof (e.g. touch screen 54, RFID reader 62, card reader 68, etc. in FIG. 3), or over a local network to which the kiosk is connected (e.g., through a user interface 22 that is configured to allow a customer to communicate with the kiosk via, for example, Bluetooth, Wi-Fi, etc.). Kiosk 12 may be further configured to detect a customer's/potential customer's presence using, for example and without limitation: a sensor (e.g., a proximity sensor (e.g., proximity sensor 56 in FIG. 3), a motion detector, and/or other suitable sensor); a surveillance camera and/or some other image capturing device or system that is electronically connected to ECU 18; GPS-based techniques; and any number of other suitable means. In another exemplary embodiment, in addition or instead of causing one or more attention grabbing actions to occur only upon detection the presence of person, kiosk 12 may be configured to periodically cause the action(s) to occur independent of the detection of the presence of a person. For example, kiosk 12 may cause the one or more actions to occur at particular times, such as, for example, times when the traffic around the kiosk is known to be heavy and/or times when the kiosk has been idle for certain amount of time, to name a few.

In any event, in an exemplary embodiment, the one or more attention grabbing actions that may be caused to occur may include, for example, the outputting of any number of attention grabbing alerts that are intended to attract the person's interest. In an exemplary embodiment, these alerts may take any number of forms. One type of alert may be an audio alert, such as, for example and without limitation: the broadcasting of a message directed to the customer/potential customer to effect of “do you want a cup of coffee?”; the starting of a noise-generating process, such as, for example, a grinding, percolating, or steaming process; and the simulation of the sound produced by a process such as those identified above. In an embodiment wherein one or more alerts comprises an audio alert, ECU 18 (or another suitable component of kiosk 12) may be configured to control outputting of such alerts. For example, in an instance wherein the alert comprises either broadcasting a message or simulating a sound, ECU 18 may be configured to acquire the appropriate content from a memory or other storage device thereof or accessible thereby, and to then cause the alert to be output at the appropriate time. This may include for example, outputting the alert(s) through a speaker (e.g., speaker 58 in FIG. 3) of kiosk 12. In an instance wherein the alert comprises the sound that is produced when a process is actually performed, ECU 18 may be configured to cause one or more process modules 20 configured to perform the particular process to initiate the process at an appropriate time. Accordingly, it will be appreciated that audio alerts may take any number of forms and be generated in a number of ways, and as such, the present disclosure is not intended to be limited to any one particular audio alert or means by which such alerts are generated or displayed.

Another type of attention grabbing alert may be a visual alert. A visual alert may comprise, for example and without limitation, various displays of lights or other types of visual displays (e.g., animations, video clips, and the like). In an embodiment wherein one or more alerts comprises a visual alert, ECU 18 may be configured to control outputting of such alerts by, for example, acquiring the appropriate content from a memory or other storage device thereof or accessible thereby, and then causing the alert to be output at the appropriate time. This may include for example, outputting the alert(s) on a visual display (e.g., a user interface 16) of kiosk 12. It will be appreciated that visual alerts may take any number of forms and be generated and/or displayed in a number of ways, and as such, the present disclosure is not intended to be limited to any one particular visual alert or means by which such alerts are generated or displayed.

Yet still another type of alert may be an aromatic alert. An aromatic alert may comprise the emission of a fragrance or aroma that may be pleasing to a customer/potential customer and that also attracts their attention. In an exemplary embodiment, this aroma may be that of coffee or some other beverage produced by the kiosk, and may be emitted from the kiosk through, for example, one or more vents or suitable ports thereof. The aroma may be natural or artificial.

In the first instance, the aroma may be emitted simply by performing one or more processes for producing a particular beverage. (e.g., grinding, brewing, etc.). Accordingly, at the appropriate time, ECU 18 (or another suitable component thereof) may simply cause one or more process modules 20 configured to perform the particular process to initiate the process. In an exemplary embodiment, a fan (e.g., fan 184 in FIG. 3) may be utilized to pull or expel the aroma out from the interior of the kiosk and to disperse it externally thereto. The operation of the fan may be controlled by, for example, ECU 18. In another exemplary embodiment, rather than initiating an aroma-producing process each time an alert is required, the aroma generated during previous performances of the corresponding process may be captured in, for example, a container or chamber, and may then be released when an alert is required. This may also include the utilization of a fan to disperse the aroma.

Rather than the aroma comprising a natural aroma as described above, in another exemplary embodiment, the aroma may be an artificially produced aroma. In such an embodiment, kiosk 12 may include one or more atomizers or other suitable devices containing a solution in a chamber or container thereof embodying the desired aroma. ECU 18 (or another suitable component of kiosk 12) may be configured control the operation of the atomizer (represented as atomizer 186 in FIG. 3) so as to control the dispersion of the solution therefrom. Accordingly, at the appropriate time, ECU 18 may cause the actuation of a nozzle of the atomizer to cause a predetermined amount of the solution in the atomizer to be dispersed therefrom as a spray or mist, for example. In another exemplary embodiment, a canister of compressed air may be utilized such that at the appropriate time, the nozzle thereof may be actuated to cause a predetermined amount of the gas therein to be dispersed therefrom. In such an embodiment, ECU 18 may be configured to control the operation of the nozzle, and therefore, the dispersion of the gas. In either instance, a fan (e.g., fan 184 in FIG. 3) may be utilized to further disperse the spray, mist, or gas, and therefore, the desired aroma.

In addition to emitting the aromatic alerts, in exemplary embodiment, kiosk 12 may be further configured to sense the level or concentration of the aroma in a particular area using well known techniques, such as, for example, chemical processes employing carbon dioxide sensors. The sensed or measured value may then be provided to, for example, ECU 18 which may then alter the level by further emissions based on the sensed level/concentration, if necessary or desired.

While each of the alerts described above have been done so exclusive of the others, in various embodiments, one or a combination of two or more of different types of alerts may be output at the same time. While certain types of alerts have been described in detail above, the present disclosure is not intended to be limited to only those particular alerts. Rather, it will be appreciated that any number of alerts in addition to those described above may be used to attract a customer's/potential customer's attention, and such additional alerts remain within the spirit and scope of the present disclosure.

In an exemplary embodiment, system 10 may further include a feature that allows customers to share latte art used in the production of various beverages with each other. More particularly, a customization option for a particular type of beverage may allow a customer to create their own latte art using commercially available or custom software and formatted data, or using a proprietary application that allows the customer to draw their own latte art, which may be output as a data file formatted for use at a kiosk. The file may be interpreted by, for example, ECU 18 (or another suitable component of a kiosk), which may then control various actuators and/or other mechanical components to create the latte art. In an exemplary embodiment, through the use of a user interface such as, for example, one or more of user interface(s) 16 and/or user interface(s) 22, a customer may share latte art they created, or alternatively, predesigned latte art, with other people. According, in such an embodiment, a customer or user may select the latte art they would like to share and then the data file corresponding thereto may be sent to the intended recipients via, for example, electronic mail, short message service (SMS), or any number of ways well known in the art and supported by system 10.

### Networking of Kiosks and Central Host

As was described above, each kiosk 12 is configured to communicate with central host 14 and, in certain embodiments, one or more other kiosks 12. As was also described above, this communication may be facilitated over any number of different types of networks and using any number of different types of communication techniques/protocols, such as, for example those described above.

In an exemplary embodiment, kiosks 12 and central host 14 that are networked together may be used as a distributed server/computing structure in order to perform, for example, various functions, interfacing, data storage, data caching, and data retrieval. In an exemplary embodiment, this may be achieved or accomplished using various known data duplication and synchronization techniques on a central host/kiosk basis, as well as a multiple kiosk basis.

More particularly, when a new kiosk 12 is installed in system 10, a new network node (i.e., a server or computing node) is effectively created that may process orders, store data, etc. In an exemplary embodiment, each time a node or kiosk is added to system 10, a corresponding IP address is assigned to that kiosk by central host 14. The IP address may be a static IP address, or alternatively, a dynamic IP address in embodiments in which a dynamic domain name service (DNS) is utilized. Accordingly, in general terms, all that may be necessary when a new kiosk is added to system 10 is the updating of geographically-based DNS entries to include that kiosk.

In an exemplary embodiment, each kiosk 12 is configured with data architecture and fail safe mechanisms that allow for redundancy and continued operation of kiosk 12 in the event communication with the central host 14 is compromised for any reason, such as, for example, central host 14 not operating properly (or at all), the network over which kiosk 12 and network host 14 communicate being unavailable, etc.

For example, and as described above, in an exemplary embodiment, each kiosk 12 is configured to create and manage its own beverage production queue(s). In such an embodiment, central host 14 may store the queues for each kiosk 12 of system 10 so as to be able to, for example, display them to customers when customers are ordering beverages or are checking on the status of their beverages via user interfaces 22, but does not otherwise control the queues. Accordingly, in an exemplary embodiment, each kiosk 12 is configured to periodically update the queue stored at central host 14 so that central host 14 has the most up to date information for the queue(s) of that corresponding kiosk 12. In an exemplary embodiment, this synchronization may take place upon the occurrence of a triggering event, such as, for example, whenever there is a change to the queue (e.g., a new beverage is ordered, a beverage is completed, the production of a beverage is initiated or moves to a different stage of the production process, etc.), or there is a request from central host 14 to do so. Alternatively, a kiosk 12 and central host 14 may be automatically synchronized periodically.

Similarly, in an exemplary embodiment, central host 14 may store various types of information that may be required for a given kiosk 12 to sufficiently operate. This information may include, for example, beverage recipes, customer-specific information (e.g., beverage preferences, order histories, loyalty program information, account information, etc.), operational parameters for different components of the kiosk, as well as any number of other types of information or data. In an exemplary embodiment, rather than only storing such information at central host 14 and providing it to the kiosk(s) 12 in response to a request to do so or on as needed basis, kiosk 12 may be configured to locally cache (e.g., in a memory or other suitable storage device that is part of or accessible by ECU 18) all of the necessary information required for it to operate independently of control host when communication between kiosk 12 and control host 14 is compromised. To that end, in an exemplary embodiment, each kiosk 12 and central host 14 may be automatically synchronized with each other periodically so that the information/data stored at the kiosk is as up to date as possible. The components may additionally or alternatively be synchronized each time a triggering event occurs, such as, for example, central host 14 determines a change has been made to the information/data that a particular kiosk may need, or upon a request to do so from a kiosk.

One of advantage of the above described architecture and configuration is that with the exception of the ability to receive requests to produce one or more beverages placed remotely through central host 14, kiosk 12 may maintain seamless continuous operation if there is a problem with the network or central host 14. Accordingly, if the network or central host 14 experiences problems, kiosk 12 is able to continue to fill orders already in the kiosk's queue, as well as to receive and fill new orders placed locally at kiosk 12 through a user interface 16 thereof, or through user interfaces 22 displayed on devices connected to a local network to which that kiosk 12 is also connected (e.g., Bluetooth, Wi-Fi, etc.). In the latter instance, or if a customer is trying to order a beverage remotely and not with respect to any particular kiosk, if the customer is placing an order through a software application on his smart phone, tablet, etc., the access codes and encryption corresponding to the local network that an available kiosk is connected to may be built into the application so that the customer may be automatically routed to a machine within range.

As was briefly described above, in an exemplary embodiment wherein system 10 includes a plurality of kiosks 12, the individual kiosks that are networked together may be configured to communicate with each other. For example, kiosks 12 may be configured to ping each other to determine whether there is a problem or failure with central host 14, the network over which the kiosk communicates with central host 14, or the kiosk itself. Accordingly, if, for example, a kiosk 12 has sent an inquiry to central host 14 and does not receive a response either in the nature of a receipt acknowledgment or the requested information, that kiosk may then ping another kiosk to allow it to diagnose where the problem may be.

In an exemplary embodiment, the networking of two or more kiosks 12 together may also provide the ability to share information between kiosks in a similar manner to that described above with respect to the sharing of information between a kiosk 12 and central host 14. Accordingly, in an exemplary embodiment, each kiosk 12 may be configured to share information with one or more other kiosks that may be required for the one or more other kiosks to sufficiently operate. This information may include, for example, beverage recipes, customer-specific information (e.g., beverage preferences, order histories, loyalty program information, account information, etc.), operational parameters for different components of the kiosk, as well as any number of other types of information or data. To that end, in an exemplary embodiment, two or more kiosks 12 may be automatically synchronized with each other periodically so that some or all of the information/data stored at one kiosk is also stored at one or more other kiosks. Additionally, or alternatively, the kiosks may be synchronized each time a triggering event occurs, such as, for example, a change has been made to the relevant information/data, or upon a request to do so from one of the kiosks.

In an exemplary embodiment, another feature of system 10 relates to the ability of some or all of the components thereof to communicate with each other over multiple networks and/or using multiple communication techniques/protocols. For example, in an exemplary embodiment, one or more kiosks 12 may be configured to communicate with host 14 and, in various embodiments, each other, over a primary network, but may also be configured to switch or fail over to one or more secondary or back-up network(s) in the event a problem occurs with the primary or first network. For example, kiosk(s) 12 may be configured to communicate with central host 14 and/or each other over an internet connection, as well as over a dial-up connection, which may already be built into the system for processing credit card payments, for example. Alternatively, rather than having a primary and one or more secondary networks, the components may be configured to select a network over which to communicate based on, for example, whether one or more other networks are inactive or operating less than optimally, the particular network(s) supported by a particular component(s) with which a component wishes to communicate, etc. Accordingly, the ability to communicate over multiple networks adds one or more layers of redundancy and/or flexibility that may further optimize the operation and performance of system 10.

### Training Kiosks

Another aspect of the present disclosure relates to the ability of a kiosk to train itself so that it optimally and efficiently performs regardless of the conditions (e.g., such as, for example, characteristics of the equipment being used to perform various functionality) or parameters (e.g., environmental and/or operational) relating to its operation. This may include, for example, adapting the operation of one or more process modules, as described in detail above, as time goes on. This may also include placing a kiosk in a training location prior to deploying it into the field to allow it to adapt to, for example, the particular equipment used in the process modules. In an exemplary embodiment, the training location may be similar to the location into which the kiosk will ultimately be deployed so as to allow the kiosk to also adapt to environmental parameters, such as, for example, temperature, humidity, barometric pressure, etc.

Apart from adapting the operation of one or more process modules, in an exemplary embodiment, the kiosk may also be trained to, for example, perform various marketing functions, such as, for example, how to up-sell customers to higher value products, how to increase prices when migrating a customer to higher end products, and the like. Accordingly, a kiosk may be configured with the intelligence to perform any number of functions in any number of areas, and to continuously improve the efficiency and optimization of the kiosk and system 10 as a whole.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A system, comprising:
a central host comprising a database; and
a kiosk configured for communication with the central host, the kiosk comprising:
an electronic control unit (ECU);
a plurality of process modules, each of which is configured to be controlled by the ECU to perform one or more chemical or mechanical processes contributing to the production of brewed beverages; and
a memory device suitable for storing information required for the operation of the kiosk, wherein the memory device is accessible by the ECU;
wherein information required for the operation of the kiosk is stored in the database of the central host and also stored in the memory device of the kiosk to allow the kiosk to operate independently of the central host when communication between the kiosk and central host is compromised.

2. The system of claim 1, wherein the kiosk and the central host are configured to communicate with each other over a plurality of different of networks.

3. The system of claim 1, wherein the information required for the operation of the kiosk comprises at least one of:
recipes for brewed beverages produced by the kiosk;
information relating to particular customers; and
operational parameters for the process modules of the kiosk.

4. The system of claim 1, wherein the kiosk further comprises a user interface configured to allow a customer to request the production of one or more brewed beverages, and further wherein the ECU is configured to receive requests to produce one or more brewed beverages made through the user interface when communication between the kiosk and the central host is compromised.

5. The system of claim 1, wherein the ECU is configured to receive requests to produce one or more brewed beverages made through a wireless network to which the kiosk is connected when communication between the kiosk and the central host is compromised.

6. The system of claim 1, wherein the memory device of the kiosk comprises a memory device of the ECU.

7. The system of claim 1, wherein the memory device of the kiosk is separate from but electrically connected to the ECU.

8. The system of claim 1, wherein the ECU is configured to create and manage a beverage production queue that includes all requests for the production of one or more brewed beverages received by the kiosk, and further configured to communicate the queue to the central host.

9. The system of claim 8, wherein the queue is created and managed based on desired delivery times for the requested brewed beverages.

10. The system of claim 1, wherein the ECU is a first ECU and the kiosk further comprises a second ECU configured to create and manage a beverage production queue that includes all requests for the production of one or more brewed beverages received by the kiosk, and further configured to communicate the queue to the central host.

11. The system of claim 1, wherein the memory device of the kiosk is configured to be periodically updated with new information received from the central host.

12. A system, comprising:
a central host; and
a kiosk configured for communication with the central host over a network and to receive requests for the production of one or more brewed beverages, the kiosk comprising:
one or more electronic control units (ECUs); and
a plurality of process modules, each of which is configured to be controlled by at least one of the one or more ECUs to perform one or more chemical or mechanical processes contributing to the production of brewed beverages;
wherein at least one of the ECUs is configured to create and manage a beverage production queue that includes all requests for the production of one or more brewed beverages received by the kiosk, and further configured to communicate the queue to the central host.

13. The system of claim 12, wherein the queue is created and managed based on desired delivery times for the requested one or more brewed beverages.

14. The system of claim 12, further comprising a user interface, and further wherein at least one of the one or more ECUs and the control host is configured to generate a graphical representation of the queue, and to control the user interface to display the graphical representation thereon.

15. A system, comprising:
a central host comprising a database; and
a plurality of kiosks, wherein each of the plurality of kiosks is configured for communication with the central host, and at least two of the plurality of kiosks are configured to communicate with each other, and further wherein each of the kiosks comprises:
an electronic control unit (ECU);
a plurality of process modules, each of which is configured to be controlled by the ECU to perform one or more chemical or mechanical processes contributing to the production of brewed beverages; and
a memory device suitable for storing information required for the operation of the kiosk, wherein the memory device is accessible by the ECU;
wherein for each of the plurality of kiosks, information required for the operation of the kiosk is stored in the database of the central host and also stored in the memory device of the kiosk to allow the kiosk to operate independently of the central host when communication between the kiosk and the central host is compromised.

16. The system of claim 15, wherein the at least two of the plurality of kiosks are configured to communicate with each other over a plurality of different networks.

17. The system of claim 15, wherein each of the plurality of kiosks are configured to communicate with the central host over a plurality of different networks.

18. The system of claim 15, wherein the at least two of the plurality of kiosks are configured to communicate with each other when communication between at least one of those kiosks and the central host is compromised.

19. The system of claim 15, wherein one or both of the at least two of the plurality of kiosks are configured to communicate information required for the operation of the other of the at least two of the plurality of kiosks to that other kiosk.
